(19) United States
(12) Patent Application Publication
(10) Pub. No.: US 2011/0013602 A1
(43) Pub. Date: Jan. 20, 2011

(54) MOBILE TERMINAL

(75) Inventor: Keigo Aso, Kanagawa (JP)

Correspondence Address: PEARNE & GORDON LLP, 1801 EAST 9TH STREET, SUITE 1200, CLEVELAND, OH, 44114-3108, US

(73) Assignee: PANASONIC CORPORATION, Osaka (JP)

(21) Appl. No.: 12/867,131

(22) PCT Filed: Mar. 3, 2009
(86) PCT No.: PCT/JP2009/000953

§ 371 Date: Aug. 11, 2010

(30) Foreign Application Priority Data
Mar. 6, 2008 (JP) 2008-056756
Jul. 29, 2008 (JP) 2008-194938

(51) Int. Cl. H04J 3/00

(52) U.S. Cl. 370/336

(57) ABSTRACT

A technology is disclosed for providing a mobile terminal that can prevent occurrence of packet loss and prevent communication delay. Based on the technology, the mobile terminal performs packet communication via a communication network with a communication terminal that is a communication partner of the mobile terminal, using a binding cache including address information of the communication terminal. The mobile terminal includes a measuring means 26 for measuring an amount of time elapsed from the end of the latest communication with the communication terminal to the start of new communication, a storage means 25 for storing information on a valid period of the binding cache, a judging means 27 for judging whether the measured elapsed time exceeds the valid period of the binding cache when communication with the communication terminal is started, a packet generating means 27 for, when the elapsed time is judged to exceed the valid period of the binding cache, setting a home address of the communication terminal as a destination address of a packet to be transmitted and generating the packet, and a transmitting means 21 for transmitting the generated packet to the communication terminal.

### TECHNICAL FIELD

The present invention relates to a mobile terminal that performs packet communication via a communication network with a communication partner.

### BACKGROUND ART

A mobile node (also referred to, hereinafter, as MN) that uses mobile IP (refer to Non-patent Document 1) registers a care-of address (also referred to, hereinafter, as CoA) that is the address of a movement destination to a home agent (also referred to, hereinafter, as HA) that manages the home address (also referred to, hereinafter, as HoA) of the mobile node itself or to a communication partner (also referred to, hereinafter, as a correspondent node [CN]), and requests forwarding of packets addressed to the HoA. If the MN is capable of registering a plurality of CoA simultaneously in association with a single HoA, the MN that has a plurality of interfaces can, by registering the CoA assigned to each interface, instantaneously switch the CoA to be used depending on the state of the interface. Non-patent Document 2 discloses, as a method by which the MN registers a plurality of CoA to the HA in association with a single HoA, a method using a binding identifier (BID).

Positional information of the MN registered to (entered in) the HA and the CN is referred to as a binding cache (also referred to, hereinafter, as BC). A lifetime indicating a valid period of the positional information is set in each entry. When the MN wishes to keep a registered binding cache, the MN transmits a binding update message (also referred to, hereinafter, as a BU message) before the lifetime expires and extends the lifetime. On the other hand, when the lifetime expires, the entry is automatically deleted.

For example, when the CN and the MN communicate, when the CN registers a binding cache to the MN, regarding a packet to be transmitted to the CN, the MN sets the destination to the CoA registered in the binding cache and transmits the packet. As a result, the transmitted packet is directly sent to the CN at the movement destination, without going through the home agent of the CN.

When the CN does not communicate with the MN after the end of the communication, the CN judges that the binding cache registered to the MN is not required to be kept. As a result, because the BU message for extending the lifetime of the binding cache is not transmitted, the binding cache registered to the MN is automatically deleted after the lifetime expires. On the other hand, when the MN starts communication with the CN after the end of the communication, when the binding cache of the CN is still present, the MN can transmit a packet using the CoA registered in the binding cache as the destination address.

Non-patent Document 1: D. Johnson, C. Perkins, J. Arkko, “Mobility Support in IPv6”, RFC3775, June 2004

Non-patent Document 2: R. Wakikawa, T. Ernst, K. Nagami, V. Devarapalli, “Multiple Care-of Addresses Registration”, draft-ietf-monami6-multiplecoa-05.txt, January 2008

However, when the CN does not communicate with the MN after the end of the communication between the CN and the MN, the CN judges that the binding cache registered to the MN is not required to be kept. As a result, because the BU message for extending the lifetime is not transmitted, the binding cache registered to the MN is not updated even should the CN move to another network and acquire another CoA.

Moreover, because setting the lifetime of the binding cache registered to the MN to an amount of time required for actual communication is difficult, even when the actual communication has ended, a state in which the binding cache remains may occur. Therefore, regarding the binding cache held by the MN, a situation may occur in which the registered CoA no longer indicates the correct movement destination of the CN regardless of the lifetime being effective. As a result, when the MN starts communication with the CN, the MN transmits a packet using the CoA registered in the binding cache of which the lifetime is still effective as the destination address. Therefore, the packet is not forwarded to the CN that has moved to a new movement destination, and packet loss occurs.

When a packet that does not use route optimization is received from the CN, a situation may occur in which the MN holds a binding cache of the CN that has an effective lifetime. As a result, the MN transmits a packet using the CoA registered in the held binding cache of the CN as the destination. Therefore, the packet is not forwarded to the CN that has moved to a new movement destination, and packet loss occurs.

### DISCLOSURE OF THE INVENTION

In light of the above-described issues, an object of the present invention is to provide a mobile terminal that can prevent occurrence of packet loss and prevent communication delay. In addition, an object of the present invention is to provide a mobile terminal that can reduce processing load and traffic accompanying unnecessary transmission of BU messages.

To achieve the above-described object, the present invention provides mobile terminal that performs packet communication via a communication network with a communication terminal that is a communication partner of the mobile terminal using a binding cache including address information of the communication terminal, the mobile terminal including: a measuring unit configured to measure an amount of time elapsed from the end of the latest communication with the communication terminal to the start of new communication; a storage unit configured to store information on a valid period of the binding cache; a judging unit configured to judge whether the measured elapsed time exceeds the valid period of the binding cache when communication with the communication terminal is started; a packet generating unit configured, when the elapsed time is judged to exceed the valid period of the binding cache, to set a home address of the communication terminal as a destination address of a packet to be transmitted and to generate the packet; and a transmitting unit configured to transmit the generated packet to the communication terminal. As a result of the configuration, occurrence of packet loss can be prevented and communication delay can be prevented. The valid period of the binding cache is equivalent to a BC usable period, described hereafter. The elapsed time is equivalent to a post-communication-end elapsed time timer, described hereafter.

In addition, in the mobile terminal of the present invention, a preferred aspect of the present invention is that the packet generating unit adds the address information of the communication terminal in the binding cache to the packet. As a result of the configuration, processing load and traffic accompanying unnecessary transmission of BU messages can be reduced.

In addition, in the mobile terminal of the present invention, a preferred aspect of the present invention is that a receiving unit is further included for receiving a message including information on the valid period of the binding cache from the communication terminal, and the storage unit acquires the information on the valid period of the binding cache included in the received message and stores the acquired information. As a result of the configuration, information regarding whether the binding cache is valid can be acquired.

In addition, in the mobile terminal of the present invention, a preferred aspect of the present invention is that the measuring unit starts measuring the elapsed time when communication with the communication terminal ends. As a result of the configuration, an elapsed time used to determine whether the binding cache is valid can be acquired.

The present invention provides a mobile terminal that performs packet communication via a communication network with a communication terminal that is a communication partner of the mobile terminal using a binding cache including address information of the communication terminal, the mobile terminal including: a measuring unit configured to measure an amount of time elapsed from the end of the latest communication with the communication terminal to the start of new communication; a storage unit configured to store information on a valid period of the binding cache; a judging unit configured, when the binding cache includes a plurality of pieces of address information of the communication terminal, to judge whether the elapsed time measured when communication with the communication terminal is started and that corresponds to each piece of address information exceeds the valid period of the binding cache; a packet generating unit configured, when all elapsed times corresponding to the pieces of address information are judged to exceed the valid period of the binding cache, to generate a packet including notification that the pieces of address information of the communication terminal within the binding cache are pieces of address information that have already exceeded the valid period of the binding cache; and a transmitting unit configured to transmit the generated packet to the communication terminal. As a result of the configuration, occurrence of packet loss can be prevented and communication delay can be prevented.

The present invention provides a mobile terminal that performs packet communication via a communication network with a communication terminal that is a communication partner of the mobile terminal using a binding cache including address information of the communication terminal, the mobile terminal including: a receiving unit configured to receive a packet from a communication terminal; a judging unit configured to judge whether the received packet is a packet that is encapsulated by the home agent of the mobile terminal; a packet generating unit configured, when the packet is judged to be encapsulated by the home agent, to generate a packet in which address information of the mobile terminal itself is set as a transmission source address and to which a home address option including the home address of the mobile terminal itself is added; and a transmitting unit configured to transmit the generated packet to the communication terminal. As a result of the configuration, occurrence of packet loss can be prevented and communication delay can be prevented.

In addition, in the mobile terminal of the present invention, a preferred aspect of the present invention is that the address information of the mobile terminal is added to the encapsulated packet. As a result of the configuration, processing load and traffic accompanying unnecessary transmission of BU messages can be reduced.

In addition, in the mobile terminal of the present invention, a preferred aspect of the present invention is that a first message generating unit is further included for generating a message including an instruction to the communication terminal to start measuring the amount of time elapsed from the end of communication to the start of new communication when communication with the mobile terminal ends, and the transmitting unit transmits the generated message to the communication terminal. As a result of the configuration, an elapsed time used to determine whether the binding cache is valid can be acquired. As described according to the embodiments of the present invention, the first message generating unit and the second message generating unit can be a same unit (constituent element).

In the present invention, a preferred aspect of the present is that a second message generating unit is further included for generating a message including information on a valid period of a binding cache of the mobile terminal held by the communication terminal, and the transmitting unit transmits the generated message to the communication terminal. As a result of the configuration, information regarding whether the binding cache is valid can be acquired.

In addition, in the mobile terminal of the present invention, a preferred aspect of the present invention is that a processing unit is further included for, when the packet received by the receiving unit is judged to be a packet encapsulated by the home agent of the mobile terminal, resetting the elapsed time stored in the mobile terminal itself and measured from the end of communication with the communication terminal to the start of new communication. As a result of the configuration, new communication can be started.

In the present invention, a preferred aspect of the present is that, when the mobile terminal itself has a plurality of interfaces and a packet received by the receiving unit is judged to be a packet encapsulated by the home agent of the mobile terminal, the processing unit resets the elapsed time corresponding to the address information of each interface. As a result of the configuration, new communication can be started.

The present invention provides a mobile terminal that performs packet communication via a communication network with a communication terminal that is a communication partner of the mobile terminal using a binding cache including address information of the communication terminal, the mobile terminal including: a receiving unit configured to receive a packet from the communication terminal; a judging unit configured to judge whether the received packet is a packet transmitted via a home agent of the mobile terminal; a selecting unit configured, when the packet is judged to be a packet transmitted via the home agent, to select processing information that is information stored with the binding cache in a predetermined storage area and related to a predetermined process performed on the binding cache; and a processing unit configured to perform a process on the binding cache based on the selected processing information. As a result of the configuration, occurrence of packet loss can be prevented and communication delay can be prevented.

The present invention provides a mobile terminal that performs packet communication via a communication network with a communication terminal that is a communication partner of the mobile terminal using a binding cache including address information of the communication terminal, the mobile terminal including: a judging unit configured to judge whether communication with the communication terminal has ended; a selecting unit configured, when the communication with the communication terminal is judged to have ended, to select processing information that is information stored with the binding cache in a predetermined storage area and related to a predetermined process performed on the binding cache; and a processing unit configured to perform a process on the binding cache based on the selected processing information. As a result of the configuration, occurrence of packet loss can be prevented and communication delay can be prevented.

In addition, in the mobile terminal of the present invention, a preferred aspect of the present invention is that the predetermined process is at least one process among deletion of the binding cache, suspension of use of the binding cache, and start of measurement of an amount of time elapsed from reception of the packet to the start of new communication. As a result of the configuration, use of an invalid binding cache can be prevented.

In addition, in the mobile terminal of the present invention, a preferred aspect of the present invention is that the processing information is information included in a message transmitted from the communication terminal in advance. As a result of the configuration, the process to be performed can be determined.

The present invention provides a mobile terminal that performs packet communication via a communication network with a communication terminal that is a communication partner of the mobile terminal using a binding cache including address information of the communication terminal, the mobile terminal including: a message generating unit configured, when generating a message for registering the binding cache to the communication terminal, to generate a message including processing information related to a predetermined process performed on the biding cache when the packet received from the mobile terminal is a packet that passes through the home agent of the communication terminal; and a transmitting unit configured to transmit the generated message to the communication terminal. As a result of the configuration, occurrence of packet loss can be prevented and communication delay can be prevented.

The present invention provides a mobile terminal that performs packet communication via a communication network with a communication terminal that is a communication partner of the mobile terminal using a binding cache including address information of the communication terminal, the mobile terminal including: a message generating unit configured, when generating a message for registering the binding cache to the communication terminal, to generate the message including processing information related to a predetermined process performed on the binding cache when communication with the mobile terminal is judged to have ended; and a transmitting unit configured to transmit the generated message to the communication terminal. As a result of the configuration, occurrence of packet loss can be prevented and communication delay can be prevented.

In addition, in the mobile terminal of the present invention, a preferred aspect of the present invention is that the predetermined process is at least one process among deletion of the binding cache, suspension of use of the binding cache, and start of measurement of an amount of time elapsed from reception of the packet to the start of new communication. As a result of the configuration, use of an invalid binding cache can be prevented.

A mobile terminal of the present invention has the above-described configuration. The mobile terminal can suppress occurrence of packet loss and suppress communication delay. In addition, the mobile terminal can reduce processing load and traffic accompanying unnecessary transmission of BU messages.

### BRIEF DESCRIPTION OF THE DRAWINGS

FIG. 1 is a block diagram of an example of a network configuration according to a first embodiment of the present invention;

FIG. 2 is a block diagram of an example of a configuration of an MN according to the first embodiment of the present invention;

FIG. 3 is a diagram of an example of a configuration of a positional information registration message when a BU message is used according to the first embodiment of the present invention;

FIG. 4 is a diagram of an example of a binding cache of a CN held by a positional information holding unit according to the first embodiment of the present invention;

FIG. 5 is a flowchart of an example of a processing flow in a transmission packet generating unit of the MN according to the first embodiment of the present invention;

FIG. 6 is a flowchart of an example of a processing flow in a received packet processing unit of the MN according to the first embodiment of the present invention;

FIG. 7 is a block diagram of a configuration of the CN according to the first embodiment of the present invention;

FIG. 8 is a flowchart of a processing flow in a transmission packet generating unit of the CN according to the first embodiment of the present invention;

FIG. 9 is a flowchart of a processing flow in a received packet processing unit of the CN according to the first embodiment of the present invention:

FIG. 10 is a block diagram of an example of a network configuration according to a second embodiment of the present invention;

FIG. 11 is a diagram of an example of a configuration of a BU message when a plurality of CoA are registered according to the second embodiment of the present invention;

FIG. 12 is a diagram of an example of a binding cache of a CN held by a positional information holding unit of an MN according to the second embodiment of the present invention;

FIG. 13 is a flowchart of an example of a processing flow in a transmission packet generating unit of the MN according to the second embodiment of the present invention;

FIG. 14 is a block diagram of an example of a configuration of an MN according to a third embodiment of the present invention;

FIG. 15 is a diagram of an example of a configuration of a positional information registration message when a BU message is used according to the third embodiment of the present invention;

FIG. 16 is a flowchart of an example of a processing flow in a received packet processing unit of the MN according to the third embodiment of the present invention;

FIG. 17 is a diagram of an example of a binding cache of a CN held by a positional information holding unit of the MN according to the third embodiment of the present invention;

FIG. 18 is a flowchart of an example of a processing flow in a transmission packet generating unit of the MN according to the third embodiment of the present invention;

FIG. 19 is a diagram of an example of a format of a BC confirmation message when a BU message is used according to the third embodiment of the present invention;

FIG. 20 is a block diagram of an example of a configuration of the CN according to the third embodiment of the present invention;

FIG. 21 is a flowchart of an example of a processing flow in a transmission packet generating unit of the CN according to the third embodiment of the present invention; and

FIG. 22 is a block diagram of an example of a configuration of an MN according to a fourth embodiment of the present invention.

### BEST MODE FOR CARRYING OUT THE INVENTION

### First Embodiment

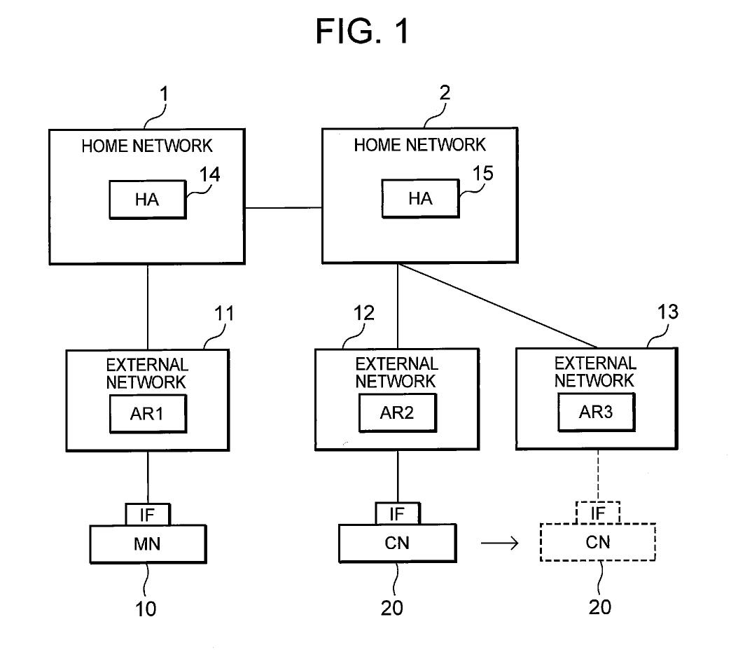

FIG. 1 is a block diagram of an example of a network configuration according to a first embodiment of the present invention. A home network 1 and a home network 2, and external networks 11, 12, and 13 are in FIG. 1. An MN 10 is managed by an HA 14 in the home network 1, and a HoA 1 is assigned as a home address. Furthermore, an interface of the MN 10 is connected to the external network 11 and assigned a CoA 1.

On the other hand, a CN 20 is managed by an HA 15 in the home network 2, and a HoA 2 is assigned as a home address. Furthermore, an interface of the CN 20 is connected to the external network 12 and assigned a CoA 2. As a binding cache of the MN 10, the HA 14 associates and holds the CoA 1 as a movement destination address for the HoA 1. As a binding cache of the CN 20, the HA 15 associates and holds the CoA 2 as a movement destination address for the HoA 2.

The home networks and HA of the MN 10 and the CN 20 can be the same home network and HA. In the descriptions hereafter, for differentiation with the MN 10, a node communicating with the MN 10 is referred to as a CN to indicate a communication partner. However, the actual CN of the present invention is a mobile node similar to the MN 10. In other words, the communication partner of the CN 20 is the MN 10, and the MN 10 can also be referred to as a CN. The network configuration shown in FIG. 1 can also be applied to a mobile phone network, such as the 3rd Generation Partnership Project (3GPP). In this instance, the HA function is actualized as a function on a network node referred to as a Packet Data Network Gateway (PDN Gateway). An AR function is actualized as a function of, for example, a serving gateway within a cellular network, an access router within a trusted network such as WiMAX, an evolved Packet Data Gateway (ePDG) that is a gateway for a Non-3GPP network (untrusted network), or the like. The MN and the CN are referred to as user equipment (UE).

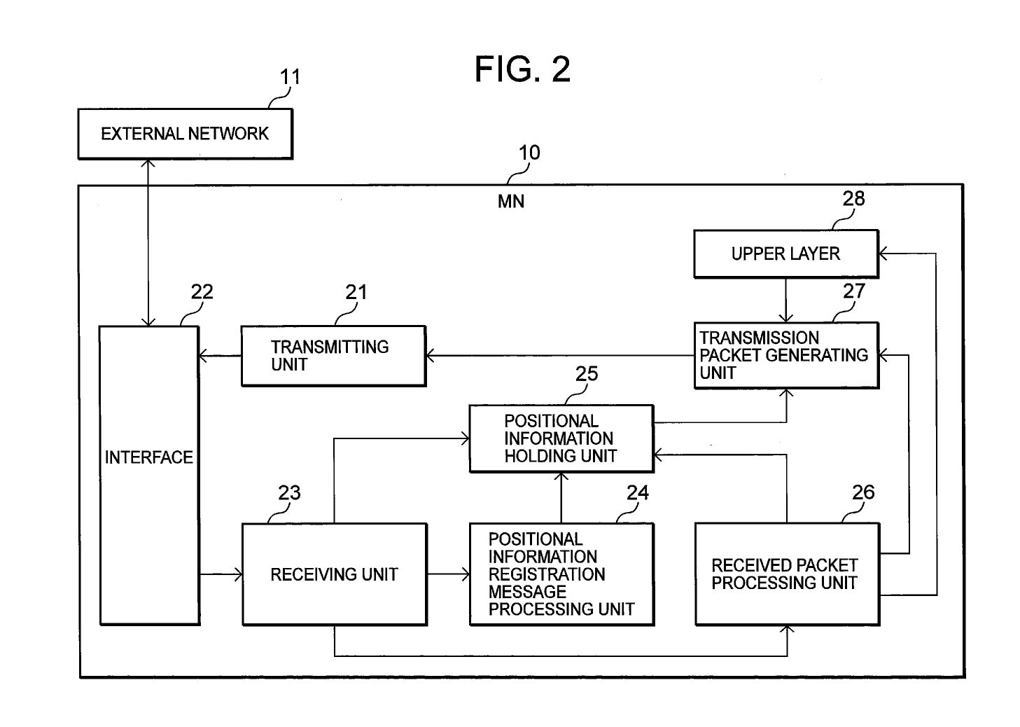

FIG. 2 is a block diagram of an example of a configuration of the MN according to the first embodiment of the present invention. The MN 10 includes, for example, the constituent elements shown in FIG. 2. A transmitting unit 21 provides a function for transmitting a packet via an interface 22 to a node on a network (external network 11) to which the MN 10 is connected. A receiving unit 23 provides a function for receiving a packet via the interface 22 from a node on a network (external network 11) to which the MN 10 is connected.

A positional information registration message processing unit 24 performs processes related to a positional information registration message received from a communication partner, associates a CoA of the communication partner included in the positional information registration message with a HoA, and instructs a positional information holding unit 25 to hold the CoA as a binding cache. In addition, a BC usable period (BC valid period) included in the positional information registration message is acquired and held within the binding cache. When the BC usable period is not included in the positional information registration message, the MN 10 itself can generate a suitable BC usable period.

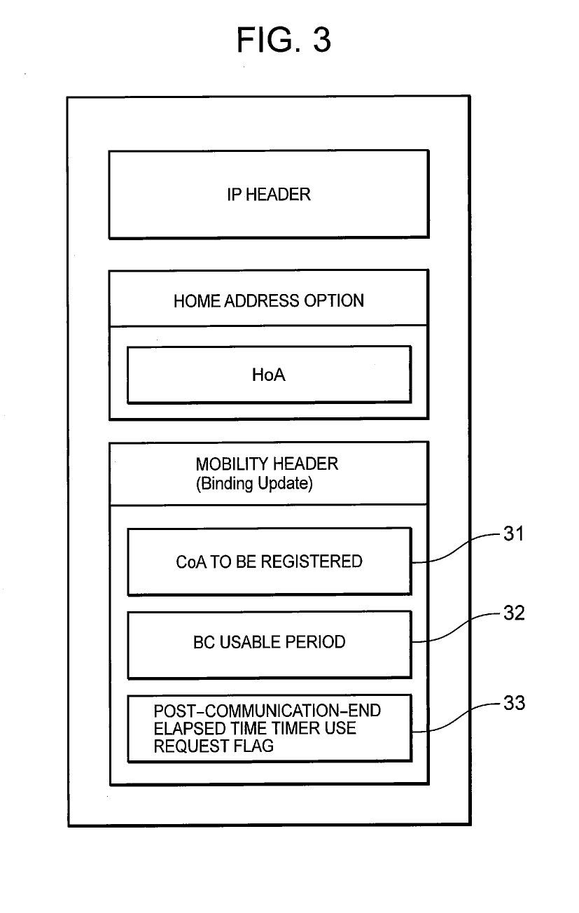

FIG. 3 is an example of a configuration of a positional information registration message when a BU message is used. As shown in FIG. 3, a BC usable period 32 is included in addition to a CoA 31 to be registered. As described above, the BC usable period can be generated on the MN 10 side instead of being included in the message. Information (post-communication-end elapsed time timer use request flag 33) can be added to the positional information registration message information to request that the MN 10 start time-measurement of a post-communication-end elapsed time timer (also referred to, hereinafter, as simply a timer) that is an amount of time elapsed from the end of communication (elapsed time from the end of communication to the start of new communication) after communication with the CN 20 has ended. The information can be indicated by inclusion of the BC usable period. When the BC usable period is not included, the request for use of the post-communication-end elapsed time timer can be indicated by a flag or the like.

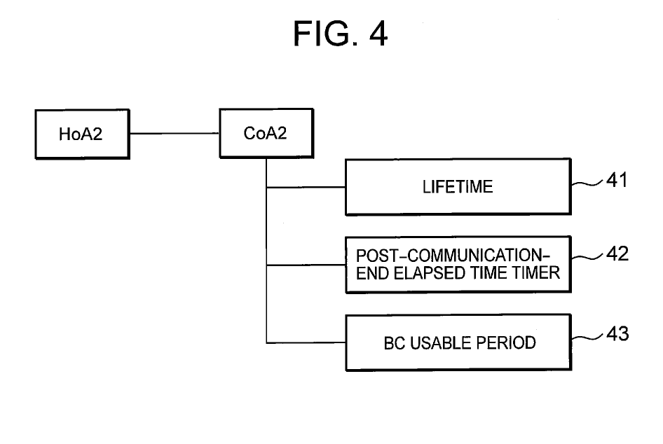

The positional information holding unit 25 holds the binding cache (including the information on the BC usable period) registered by the communication partner. An instruction from a received packet processing unit 26 or an upper layer 28 to start time-measurement of the post-communication-end elapsed time timer of the binding cache can be received. FIG. 4 shows an example of a binding cache of the CN 20 held by the positional information holding unit 25. As shown in FIG. 4, a lifetime 41, a post-communication-end elapsed time timer 42, and a BC usable period 43 of the CoA 2 associated with the HoA 2 are managed. The lifetime is the lifetime of the BC. As an ordinary binding cache lifetime, the BC usable period can be held. In this instance, in FIG. 3, the BC usable period 32 is set in the lifetime field of the BU message. A flag or the like can be included in the BU message to indicate to the receiving node that the value in the lifetime field is the BC usable period.

A transmission packet generating unit 27 generates a packet for transmitting data received from the upper layer 28 to the communication partner, sends the packet to the transmitting unit 21, and instructs the transmitting unit 21 to transmit the packet. When generating the packet, the transmission packet generating unit 27 searches the positional information holding unit 25 and checks whether a binding cache related to the communication partner is present.

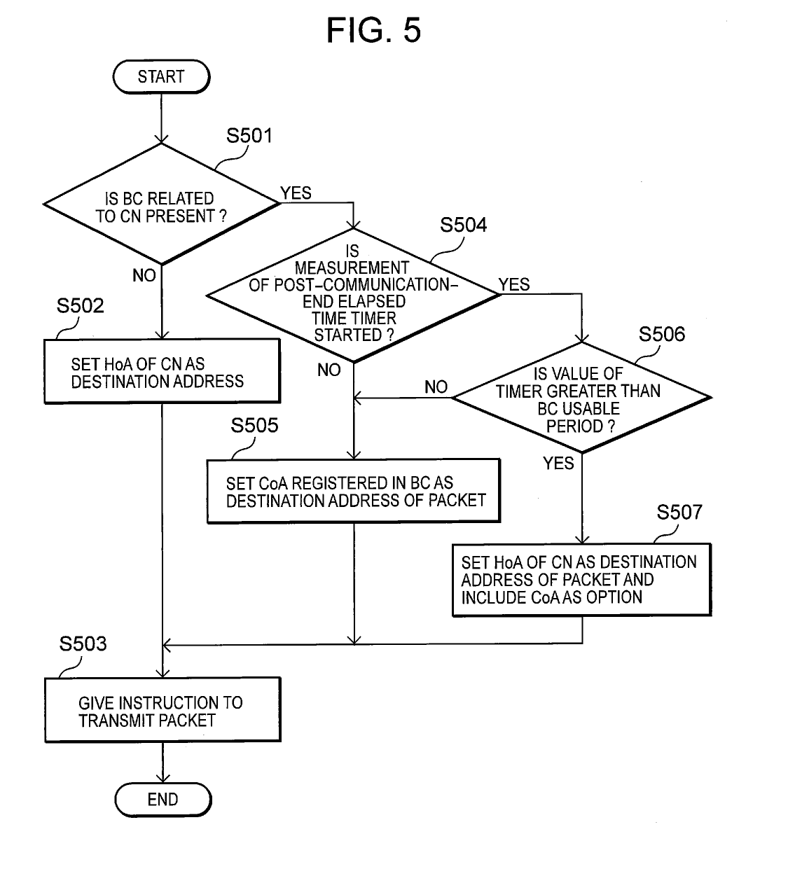

Here, an example of processes performed by the transmission packet generating unit 27 will be described using FIG. 5. When communication with the CN 20 is started, first, whether a binding cache (BC) related to the communication partner CN 20 is present is judged (Step S501). When the binding cache is not present, the HoA of the communication partner is set as the destination address of the packet (Step S502) and the transmitting unit 21 is instructed to transmit the packet (Step S503). On the other hand, when the binding cache is present, the post-communication-end elapsed time timer of the binding cache is checked and whether the time-measurement of the timer is started is judged (Step S504).

When the time-measurement of the timer is not started, the CoA registered in the binding cache is set as the destination address of the packet (Step S505) and the transmitting unit 21 is instructed to transmit the packet (Step S503). On the other hand, when the time-measurement of the timer is already started, whether the timer is greater than the BC usable period is judged (Step S506). When the timer is greater, the HoA of the CN 20 is set as the destination address of the packet and the CoA is included as an option (Step S507), and the transmitting unit 21 is instructed to transmit the packet (Step S503). On the other hand, when the timer is not greater, the CoA registered in the binding cache is set as the destination address of the packet (Step S505) and the transmitting unit 21 is instructed to transmit the packet (Step S503). At Step S505, because the packet in which the CoA is set as the destination address is a packet for when route optimization in mobile IP is used, a routing header including the HoA is included. At Step S507, as the option including the CoA, a destination option defined in IPv6 is preferably used. A BID can be used in place of the CoA.

The BC usable period can be arbitrarily set by the MN 10 as described above. Furthermore, the CN 20 can be notified of the value. In this instance, the positional information registration message from the CN 20 does not include the BC usable period for the MN 10. An operator-side entity, such as the HA or a gateway server (ePDG or PDN gateway), can also perform setting for the MN 10 and the CN 20. The MN 10 can check with the operator-side entity regarding whether the BC usable period and the post-communication-end elapsed time timer should be used. Alternatively, after the end of communication, when a message (binding revocation message) clearly requesting deletion of the BC is not received from the CN 20, a judgment can be made that the BC usable period and the post-communication-end elapsed time timer should be used.

The upper layer 28 indicates the overall layers positioned above the IP layer and includes the transport layer (TCP/UDP) up to the application layer above the transport layer. The received packet processing unit 26 provides a function for performing processes related to a packet received by the receiving unit 23. Data within the packet processed by the received packet processing unit 26 is sent to the upper layer 28 or the transmission packet generating unit 27. When communication with the CN 20 is completed, the received packet processing unit 26 and the upper layer 28 instruct the start of time-measurement of the post-communication-end elapsed time timer of the binding cache of the CN 20 held by the positional information holding unit 25. When communication with the CN 20 is not performed for a certain amount of time, the positional information holding unit 25 can start the time-measurement of the post-communication-end elapsed time timer. As a result, without an inquiry being made to the upper layer 28 and the received packet processing unit 26 regarding whether the communication has ended or a notification being received from the upper layer 28 and the received packet processing unit 26, transmission and reception of packets not being performed for a certain amount of time can be predicted to be the end of communication, and time-measurement of the timer can be efficiently started.

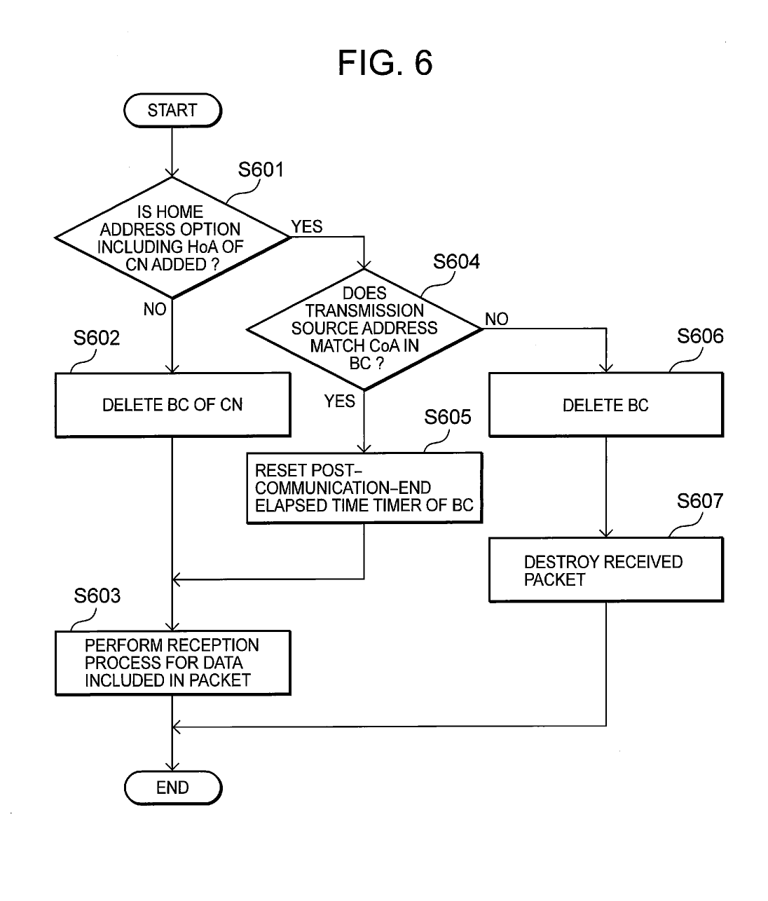

Here, an example of processes performed by the received packet processing unit 26 will be described using FIG. 6. When a packet is received from the CN 20, first, whether a home address option including the HoA of the CN 20 that is the communication partner is added to the received packet is judged (Step S601). When the home address option is not added, the packet is judged to have been forwarded via the HA. The binding cache (BC) of the CN 20 is deleted (Step S602) and a reception process for the data included in the packet is performed (Step S603).

Even after a packet is forwarded from the CN 20 via the HA without use of route optimization, to prepare for when the CN 20 resumes transmitting packets using route optimization, the post-communication-end elapsed time timer is started without deleting the binding cache at Step S602. The timer in this instance measures the amount of time during which packets from the CN 20 are transmitted without using route optimization. As a result, even when the CN 20 resumes transmitting packets using route optimization, the CN 20 is not required to register the positional information to the MN 10. In addition, the MN 10 can be prevented from using the positional information of the CN 20 after the positional information of the CN 20 exceeds the BC valid period. When the CN 20 resumes using route optimization, because the timer is reset at Step S605, the binding cache of the CN 20 held by the MN 10 can be used again. The home address option not being added to a packet indicates that the packet does not use route optimization.

On the other hand, when the home address option is added, whether the transmission source address of the packet matches the CoA registered in the binding cache is judged (Step S604). When the addresses match, the post-communication-end elapsed time timer of the binding cache is reset (Step S605). As a result, when the MN 10 transmits a packet to the CN 20, when the packet is transmitted without using route optimization because the value of the post-communication-end elapsed time timer is greater than the BC usable period, as a result of the timer being reset, when a packet is transmitted to the CN 20, route optimization using the binding cache can be used again. On the other hand, when the addresses do not match at Step S604, the packet is judged to be from an unregistered CoA, the binding cache is deleted (Step S606), and the received packet is destroyed (Step S607).

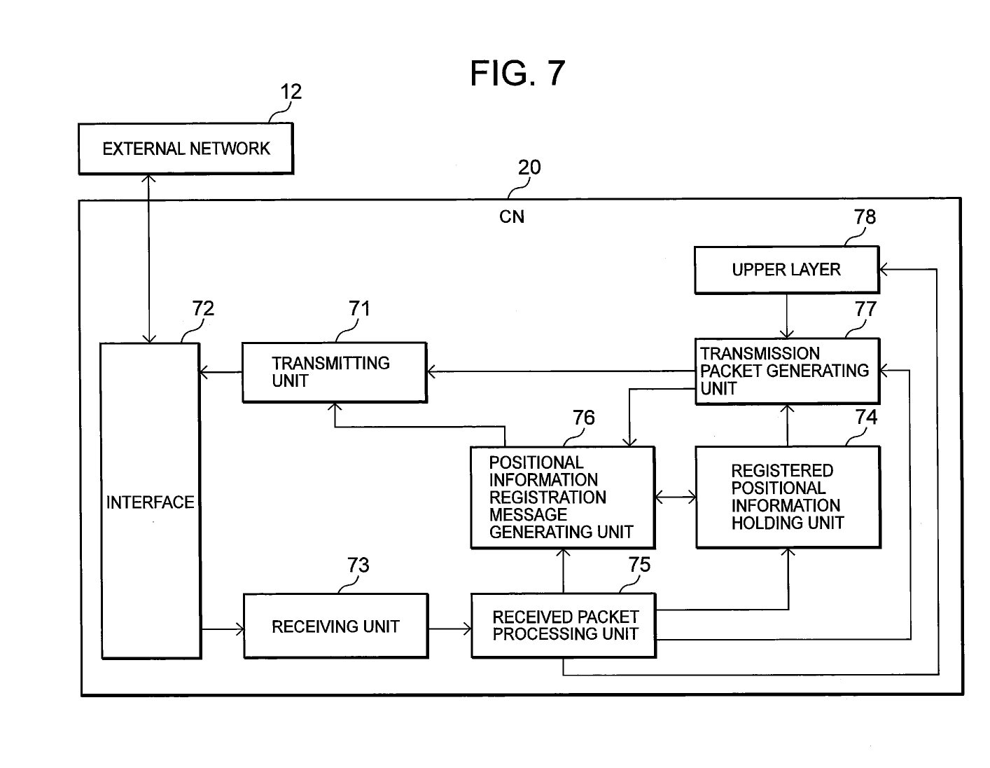

FIG. 7 is a block diagram of an example of a configuration of the CN according to the first embodiment of the present invention. The CN 20 includes, for example, the constituent elements shown in FIG. 7. A transmitting unit 71 provides a function for transmitting a packet via an interface 72 to a node on a network (external network 12) to which the CN 20 is connected. A receiving unit 73 provides a function for receiving a packet via the interface 72 from a node on a network (external network 12) to which the CN 20 is connected.

A registered positional information holding unit 74 holds information indicating that a binding cache is registered to a communication partner (such as the MN 10). An instruction is received from a received packet processing unit 75 or an upper layer 78 to start time-measurement of a post-communication-end elapsed time timer of the registered positional information. The registered positional information holding unit 74 can start the time-measurement of the post-communication-end elapsed time timer when communication with the MN 10 is not performed for a certain amount of time. As a result, without an inquiry being made to the upper layer 78 and the received packet processing unit 75 regarding whether the communication has ended or notification being received from the upper layer 78 and the received packet processing unit 75, transmission and reception of packets not being performed for a certain amount of time can be predicted to be the end of communication, and time-measurement of the timer can be efficiently started. In addition, when the lifetime of the binding cache registered to the MN 10 approaches expiration, a positional information registration message generating unit 76 is instructed to generate a positional information registration message for updating the lifetime.

The positional information registration message generating unit 76 receives an instruction from the transmission packet generating unit 77 or the received packet processing unit 75 and generates the positional information registration message for registering the binding cache to the communication partner. In addition, the BC usable period of the binding cache to be registered is included in the positional information registration message, and the transmitting unit 71 is instructed to transmit the positional information registration message.

The BC usable period is preferably set to a value suitable for the CN 20 and the MN 10 based on communication status (set to a small value when the communication status is poor and to a large value when the communication status is favorable), connection status (set to a small value when the connection status is poor and to a large value when the connection status is favorable), handover occurrence frequency (set to a small value when the handover frequency is high and to a large value when the handover frequency is low), communication data type (real-time data such as audio data and moving image data, control message, and the like), interface type (cellular, WiMAX, or WLAN), and the like. The value can be arbitrarily set based on protocol type (TCP, UDP, SIP, RTP, and the like) as well. Moreover, the value can be arbitrarily set based on the CN that is the communication partner. For example, the value can be arbitrarily set depending on whether the CN belongs to the same operator. The BC usable period held by the MN 10 is preferably greater than the BC usable period held by the CN 20.

The positional information registration message generating unit 76 receives an instruction from the registered positional information holding unit 74 and generates a positional information registration message for updating the lifetime of the MN 10 when the lifetime of the binding cache registered to the MN 10 approaches expiration. The transmission packet generating unit 77 generates a packet for transmitting data received from the upper layer 78 or the received packet processing unit 75 to the communication partner, sends the generated packet to the transmitting unit 71, instructs the transmitting unit 71 to transmit the packet. When generating the packet, the transmission packet generating unit 77 searches the registered positional information holding unit 74 and judges whether the binding cache is already registered to the node at the destination address of the packet.

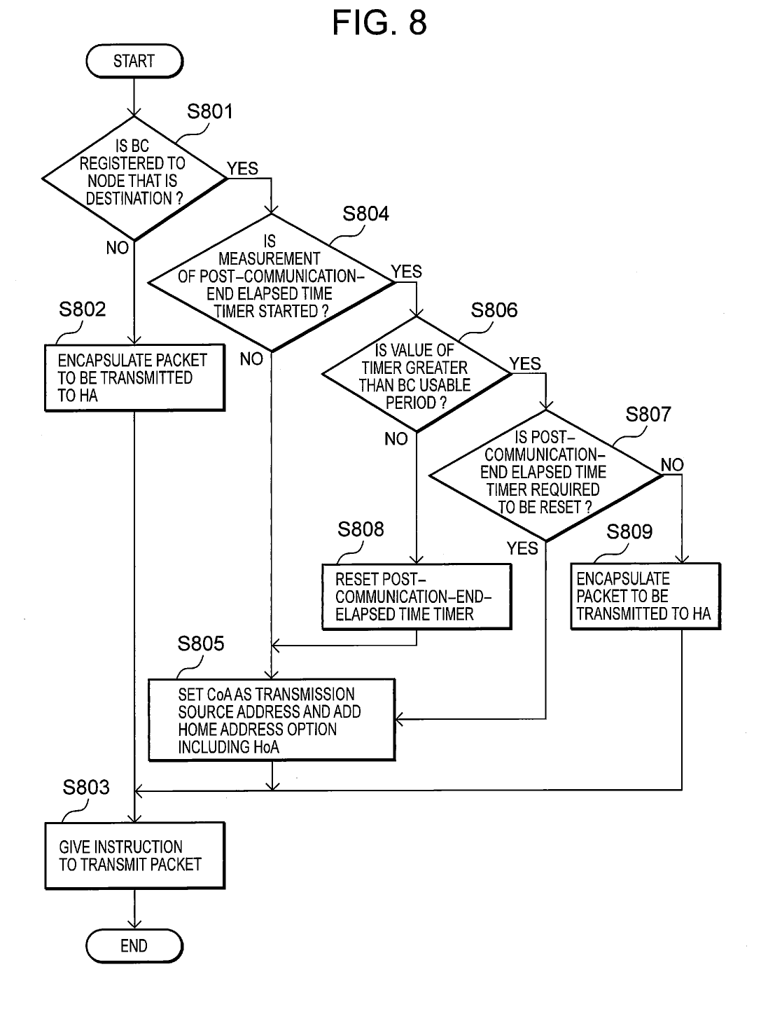

Here, an example of processes performed by the transmission packet generating unit 77 will be described using FIG. 8. When an instruction is given to transmit a packet, first, whether a binding cache is registered to the node that becomes the destination is judged (Step S801). When the binding cache is not registered, the packet to be transmitted is encapsulated to the HA (Step S802), and the transmitting unit 71 is instructed to transmit the encapsulated packet (Step S803). On the other hand, when the binding cache is registered, the post-communication-end elapsed time timer of the registered positional information is checked and whether the time-measurement of the timer is started is judged (Step S804).

When the time-measurement of the timer is not started, regarding the packet, the CoA is set as the transmission source address and a home address option including the HoA is added (Step S805), and the transmitting unit 71 is instructed to transmit the packet (Step S803). On the other hand, when the time-measurement of the timer is already started, whether the timer is greater than the BC usable period is judged (Step S806). When the timer is greater, whether the post-communication-end elapsed time timer of the binding cache of the CN 20 held by the MN 10 is required to be reset and suspension of use of the binding cash is required to be lifted is judged (Step S807). When suspension is required to be lifted, the CoA is set as the transmission source address and the home address option including the HoA is added (Step S805), and the transmitting unit 71 is instructed to transmit the packet (Step S803).

When the BC valid period of the MN 10 is greater than the BC valid period held by the CN 20, even when the post-communication-end elapsed time timer of the CN 20 becomes greater than the BC valid period, because the post-communication-end elapsed time timer of the MN 10 is still not greater than the BC valid period, as a result of the MN 10 receiving the packet generated at S805, the post-communication-end elapsed time timer of the binding cache is reset, and use of route optimization is started. On the other hand, at step S807, when the post-communication-end elapsed time timer of the binding cache of the CN 20 held by the MN 10 is not required to be reset, the packet to be transmitted is encapsulated to the HA (Step S809) and the transmitting unit 71 is instructed to transmit the encapsulated packet (Step S803). On the other hand, at Step S806, when the timer is not greater, the post-communication-end elapsed time timer is reset (Step S808) and, regarding the packet, the CoA is set as the transmission source address, and a home address option including the HoA is added (Step S805), and the transmission unit 71 is instructed to transmit the packet (Step S803). As a result, the post-communication-end elapsed time timer of the binding cache of the MN 10 is reset.

The received packet processing unit 75 provides a function for performing processes related to a packet received by the receiving unit 73. Data within the packet processed by the received packet processing unit 75 is sent to the upper layer 78 or the transmission packet generating unit 77. When communication with the MN 10 ends, the received packet processing unit 75 and the upper layer 78 makes the registered positional information holding unit 74 start the time-measurement of the post-communication-end elapsed time timer for the positional information registered to the MN 10 held by the registered positional information holding unit 74.

When a packet is received from the MN 10, the received packet processing unit 75 references the registered positional information holding unit 74, judges whether the binding cache is registered to the transmission source node of the received packet and, when the binding cache is not registered, instructs the positional information registration message generating unit 76 to generate and transmit to the MN 10 a positional information registration message.

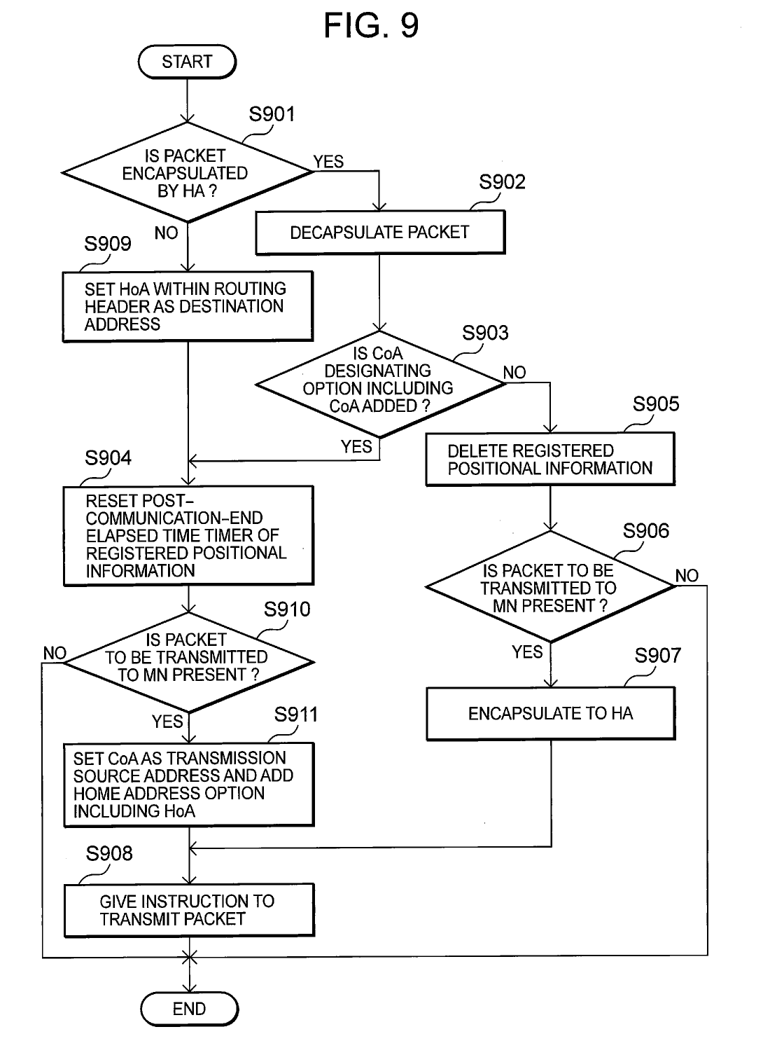

Here, an example of processes performed by the received packet processing unit 75 will be described using FIG. 9. When a packet is received from the MN 10, first, whether the received packet is a packet that is encapsulated by the HA and forwarded is judged (Step S901). When the packet is encapsulated, to perform reception as a packet destined for the HoA, decapsulation is performed (Step S902). Then, whether a CoA designating option including the CoA is added to the decapsulated packet is judged (Step S903).

When the CoA designating option is added, despite the MN 10 holding the binding cache, direction transmission to the CoA is judged to have not been performed because the post-communication-end elapsed time timer is greater than a predetermined value (BC usable period), and the post-communication-end elapsed time timer for the registered positional information is reset (Step S904). On the other hand, when the CoA designating option is not added, judgment is made that the MN 10 does not hold the binding cache and the registered positional information is deleted (Step S905). After the registered positional information is deleted, whether a packet to be transmitted to the MN 10 is present is judged (Step S906). When a packet to be transmitted is present, as a method for transmitting a packet when the binding cache is not registered to the MN 10, encapsulation to the HA is performed (Step S907) and the transmitting unit 71 is instructed to transmit the encapsulated packet (Step S908).

On the other hand, when the received packet is not a packet encapsulated by the HA and is a packet to which a routing header including the HoA is added, perform reception as a packet destined for the HoA, the HoA within in the routing header is set as the destination address (Step S909) and, furthermore, the post-communication-end elapsed time timer for the registered positional information is reset (Step S904). After the post-communication-end elapsed time timer is reset, whether a packet to be transmitted to the MN 10 is present is judged (Step S910). When a packet to be transmitted is present, as a method for transmitting a packet when the binding cache is registered to the MN 10, the CoA is set as the transmission source address and the home address option including the HoA to the packet is added (Step S911), and the transmitting unit 71 is instructed to transmit the encapsulated packet (Step S908). The method for transmission when a packet to be transmitted to the transmission source of a received packet is present achieves results equivalent to when the processes shown in FIG. 8 are performed.

Here, when the CN 20 is connected to the external network 12 and is using the CoA 2, when the MN 10 holding the binding cache related to the CoA 2 starts communication with the CN 20 will be considered. When the post-communication-end elapsed time timer of the binding cache held by the MN 10 is greater than the BC usable period, the CN 20 receives from the MN 10 a packet encapsulated by the HA and in which the CoA designating option is added to an inner packet.

Because the CoA 2 included in the CoA designating option indicates the current movement destination address of the CN 20, the CN 20 can send the packet to be transmitted to the MN 10 using a route-optimized path that does not go through the HA. Furthermore, because the CoA 2 included in the CoA designating option indicates the current movement destination address of the CN 20, the CN 20 can judge that the MN 10 still holds the correct binding cache, thereby judging that a positional information registration message for newly registering the binding cache is not required to be transmitted to the MN 10.

Next, when the CN 20 is connected to the external network 13 and is using a CoA 3, when the MN 10 holding the binding cache related to the CoA 2 starts communicating with the CN 20 will be considered. When the post-communication-end elapsed time timer of the binding cache held by the MN 10 is greater than the BC usable period, the CN 20 receives a packet encapsulated by the HA and in which the CoA designating option is added to an inner packet from the MN 10.

Because the CoA 2 included in the CoA designating option does not indicate the current movement destination address of the CN 20, the CN 20 is required to send the packet to be transmitted to the MN 10 using a path that goes through the HA. Furthermore, to update the positional information of the MN 10 with the correct movement destination address, a judgment is made that a positional information registration message is required to be transmitted to the MN 10.

Similar effects can be achieved even when some functions provided by the MN 10 according to the first embodiment of the present invention are applied to a HA 14 that manages the positional information of the MN 10. The MN 10 transmits a BU message including the BC usable period, such as that shown in FIG. 3, to the HA 14. The HA 14 sets the BC usable period within the BU message received from the MN 10 in the binding cache of the MN 10. Then, the timer is started after the end of communication between the MN 10 and the CN 20 (when a state is entered in which communication using the binding cache is not performed). The timer is reset when the MN 10 again restarts communication with the CN 20 using the CoA registered in the binding cache. Therefore, when the MN 10 does not communicate for a brief period and the timer exceeds the BC valid period, the binding cache is not used as a forwarding destination and use is suspended. In this instance, when the HA 14 has a binding cache other than the binding cache of which use is suspended (when the MN 10 holds a plurality of interfaces), the HA 14 selects and uses the other binding cache as the next forwarding destination.

On the other hand, even when another binding cache is present, if the timer of the binding cache also exceeds the BC valid period, the binding cache with the timer having the shorter elapsed time or a shorter amount of time exceeded from the BC usable period is selected. When another binding cache is not present, the HA 14 lifts the suspension of use of the binding cache and forwards the received packet to the registered CoA. As a result, a binding cache that is more likely to be valid can be selected. Instead of packet loss occurring in the HA 14, effects such as re-forwarding or buffering by a gateway within the network to which the MN 10 is connected and the like can be expected. When a binding cache indicating connection to the home network is present (HoA is set as the CoA) as another binding cache, the HA 14 forwards the packet to the HoA without encapsulating the packet. Even when another binding cache of the MN 10 is not present, when it is known that the MN 10 is connected to the home network, forwarding to the HoA can be performed.

In this way, as a result of the MN 10 and the CN 20 according to the first embodiment of the present invention, when a packet is transmitted to the CN 20, the post-communication-end elapsed time timer of the binding cache of the CN 20 held by the MN 10 itself is checked. Depending on the length of the elapsed time, whether to use the CoA in the binding cache for a packet to be actually transmitted can be judged.

Specifically, when the value of the timer is greater than the BC usable period (indicating that a certain amount of time or more has elapsed from the previous (latest) communication), a judgment is made that the CN 20 may have already moved and the binding cache may no longer be valid. The packet to be transmitted is transmitted to the HoA of the CN 20. As a result, even when the CN 20 has already moved and is using a new CoA, because forwarding to the CoA after movement is performed, an effect can be achieved in which packet loss is prevented.

In addition, because the MN 10 adds the CoA designating option including the CoA held in the binding cache to the packet and performs transmission to indicate to the CN 20 that the binding cache is still registered, the CN 20 can know that the MN 10 still holds a valid binding cache. Therefore, a positional information registration message for newly registering a binding cache is not required to be transmitted. Effects can be achieved in which processing load and traffic accompanying message transmission can be reduced.

By arbitrarily setting the value of the BC usable period notified to the MN 10 based on communication status, connection status, handover occurrence frequency, communication data type, interface type (cellular, wireless LAN such as IEEE802.a/b/g/n, or WiMAX), the CN 20 can prompt the MN 10 to make a selection that is most suitable for that point in time.

### Second Embodiment

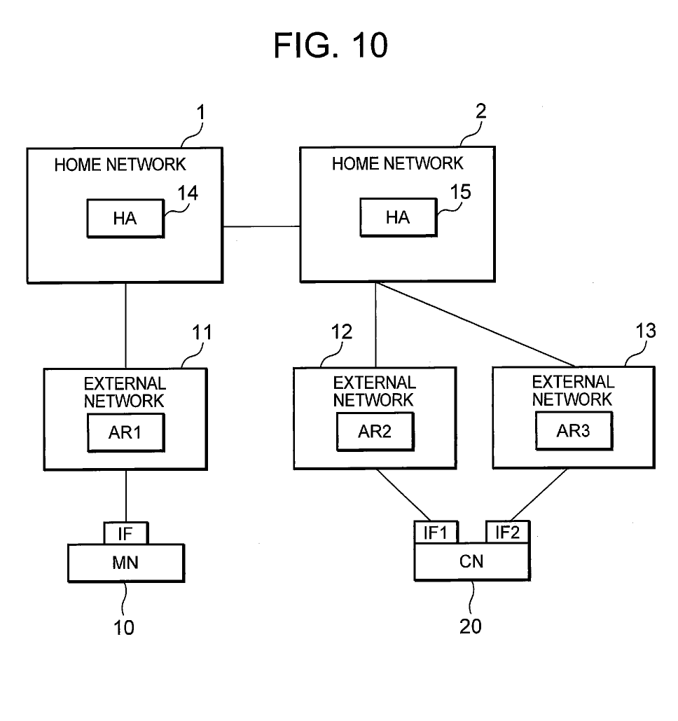

FIG. 10 is a block diagram of an example of a network configuration according to a second embodiment of the present invention. The difference between FIG. 1 and FIG. 10 is that the CN 20 holds two interfaces. An IF 1 is connected to the external network 12 and is assigned the CoA 2. An IF 2 is connected to the external network 13 and is assigned the CoA 3.

As the binding cache of the MN 10, the HA 14 holds information in which the CoA 1 associated as a movement destination address for the HoA 1. As the binding cache of the CN 20, the HA 15 holds information in which the CoA 2 and the CoA 3 are associated as movement destination addresses for the HoA 2. The home networks and HA of the MN 10 and the CN 20 can be the same home networks and HA. The CN 20 can be a mobile node similar to the MN 10.

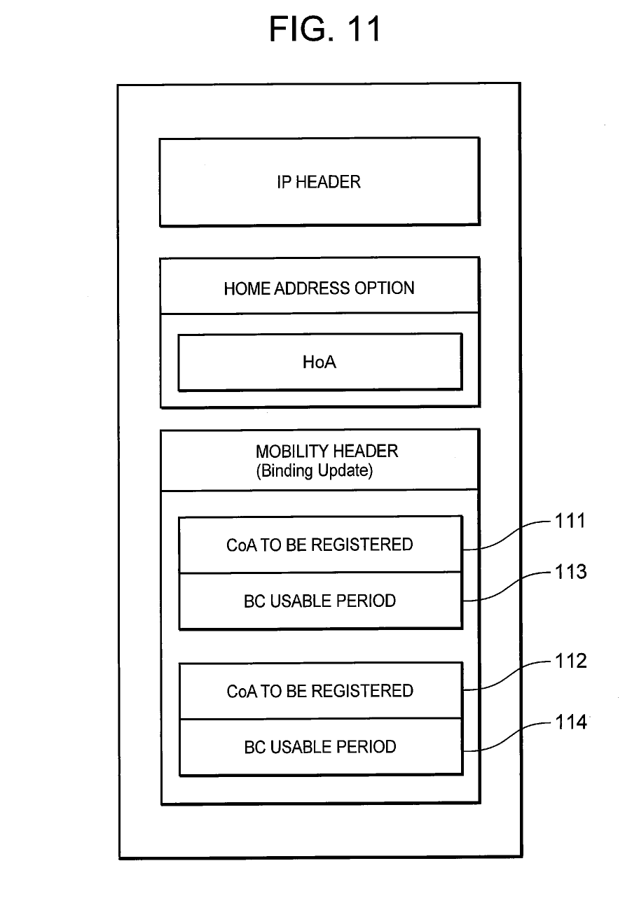

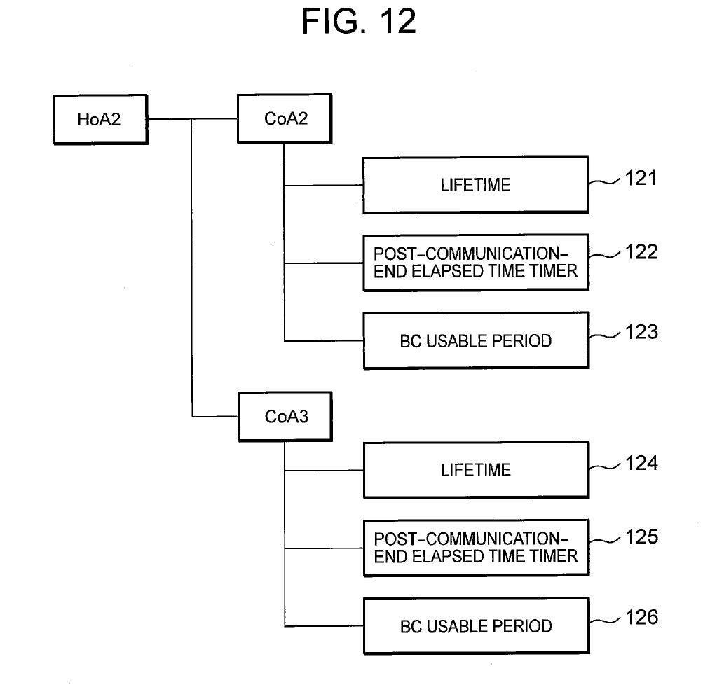

The configuration of the MN 10 according to the second embodiment of the present invention is the same as that according to the first embodiment and, therefore, will be described using FIG. 2. The difference between the first embodiment and the second embodiment is mainly processes performed by the positional information holding unit 25 and the transmission packet generating unit 27. Here, an example of a configuration of a BU message (positional information registration message) used when a plurality of CoA are registered is shown in FIG. 11. As shown in FIG. 11, BU usable periods 113 114 are respectively designated for CoA 111 and 112 to be registered. FIG. 12 shows an example of a binding cache of the CN 20 held by the positional information holding unit 25. For each CoA 2 and CoA 3 associated with the HoA 2, lifetimes 121 and 124, post-communication-end elapsed time timers 122 125, and BC usable periods 123 and 126 are managed.

The positional information holding unit 25 holds the binding cache in which a plurality of CoA are associated with a single HoA as the positional information of the CN 20. When generating a packet, the transmission packet generating unit 27 searches the positional information holding unit 25 and checks whether a binding cache related to the communication partner is present.

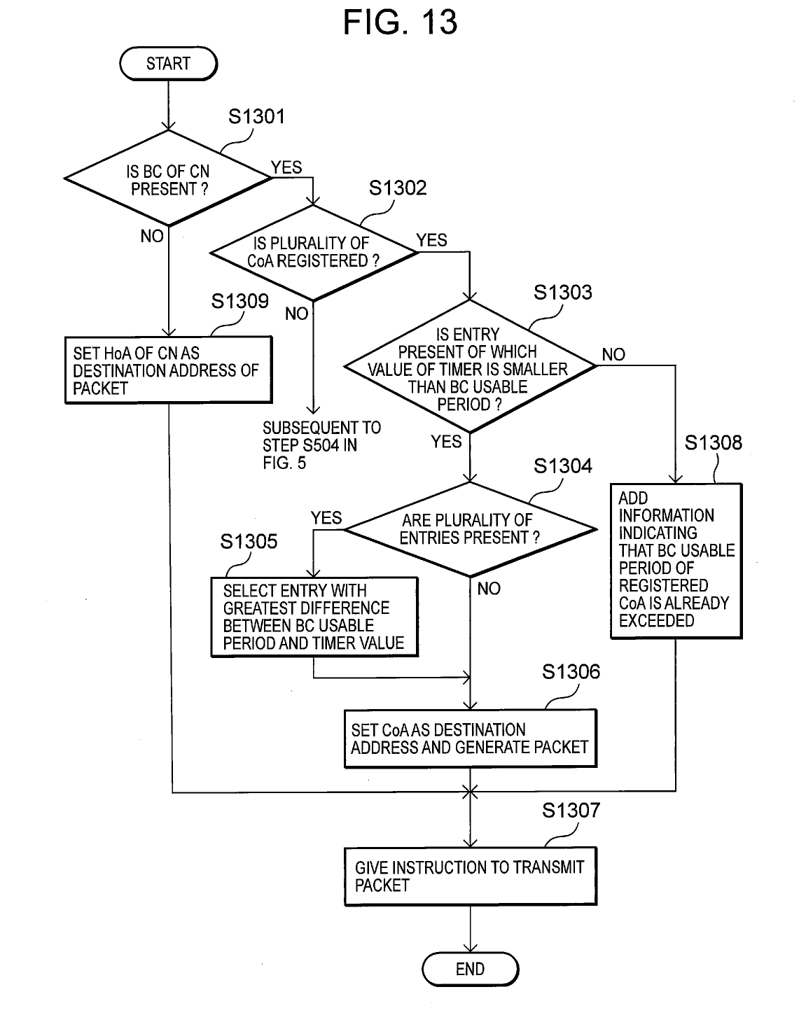

Here, an example of processes performed by the transmission packet generating unit 27 will be described using FIG. 13. When communication with the CN 20 is started, first, whether a binding cache of the CN 20 that is the communication partner is present is judged (Step S1301). When the binding cache is present, whether a plurality of CoA are registered therein is judged (Step S1302). When a plurality of CoA are registered, the post-communication-end elapsed time timer of each CoA is checked and whether an entry having a timer smaller than the BC usable period is present is judged (Step S1303).

When an applicable entry is present, whether a plurality of applicable entries are present is judged (Step S1304). When a plurality are present, the entry having the greatest difference between the BC usable period and the post-communication-end elapsed time timer is selected (Step S1305). The CoA of the entry is set as the destination address and a packet is generated (Step S1306). The transmitting unit 21 is instructed to transmit the packet (Step S1307). When a single applicable entry is present, the CoA of the entry is set as the destination address and a packet is generated (Step S1306). The transmitting unit 21 is instructed to transmit the packet (Step S1307). The generated packet is a packet in which the CoA is set as the destination address and to which a routing header including the HoA is added.

On the other hand, at Step S1303, when an applicable entry is not present, information is added to the packet indicating that the CoA of the registered (held) binding cache is a CoA of which the BC usable period is already exceeded (Step S1308). The transmitting unit 21 is instructed to transmit the packet (Step S1307). The information may be a CoA or a BID, or may be indicated as a flag within the CoA designating option.

When a binding cache is not present at Step S1301, the HoA of the CN 20 that is the communication partner is set as the destination address of the packet (Step S1309) and the transmitting unit 21 is instructed to transmit the packet (Step S1307). When a plurality of CoA are not registered at Step S1302, the processes subsequent to Step S504 in FIG. 5, described according to the first embodiment are performed.

As a result, the MN 10 can select the CoA that most likely correctly indicates the current movement destination address of the CN 20, among the registered plurality of CoA of the CN 20, and transmit the packet.

The configuration of the CN 20 according to the second embodiment of the present invention is the same as that according to the first embodiment and, therefore, will be described using FIG. 7. The difference between the first embodiment and the second embodiment is mainly the processes performed by the received packet processing unit 75 and the transmission packet generating unit 77. The received packet processing unit 75 provides a function for performing processes related to a packet received by the receiving unit 73. Data within the packet processed by the received packet processing unit 75 is sent to the upper layer 78 or the transmission packet generating unit 77.

When communication with the MN 10 is completed, the received packet processing unit 75 starts time-measurement of the post-communication-end elapsed time timer of the positional information registered to the MN 10 held by the registered positional information holding unit 74. When a packet is received from the MN 10, the received packet processing unit 75 references the registered positional information holding unit 74 and judges whether the binding cache is registered in the transmission source node of the received packet. When the binding cache is not registered, the positional information registration message generating unit 76 is instructed to generate a positional information registration message and transmit the generated positional information registration message to the MN 10.

The received packet processing unit 75 performs almost the same processes as the processes shown in FIG. 9. However, because the CoA designating option includes a plurality of CoA, each post-communication-end elapsed time timer corresponding to the CoA is reset.

### Third Embodiment

A third embodiment of the present invention will also be described using FIG. 1. The home networks and HA of the MN 10 and the CN 20 can be the same home network and HA. In the descriptions hereafter, for differentiation with the MN 10, a node communicating with the MN 10 is referred to as a CN to indicate a communication partner. However, the actual CN of the present invention is a mobile node similar to the MN 10. In other words, the MN 10 is the communication partner of the CN 20. Therefore, the MN 10 can also be referred to as a CN.

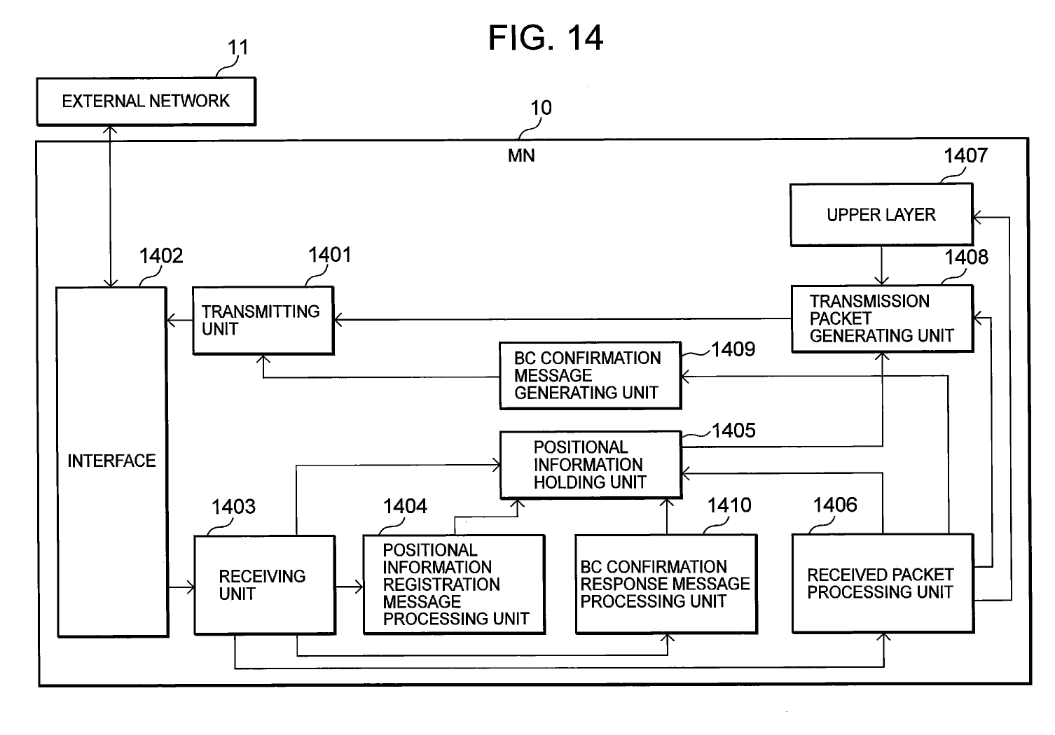

FIG. 14 is a block diagram of an example of a configuration of the MN according to the third embodiment of the present invention. The MN 10 includes, for example, the constituent elements shown in FIG. 14. A transmitting unit 1401 provides a function for transmitting a packet via an interface 1402 to a node on a network (external network 11) to which the MN 10 is connected. A receiving unit 1403 provides a function for receiving a packet via the interface 1402 from a node on a network (external network 11) to which the MN 10 is connected.

A positional information registration message processing unit 1404 performs processes related to a positional information registration message received from a communication partner, associates a CoA of the communication partner included in the positional information registration message with a HoA, and instructs a positional information holding unit 1405 to hold the CoA as a binding cache. In addition, when information (BC type information) indicating handling of the binding cache by the receiving node is included in the positional information registration message, an instruction is given to also hold the pieces of information in the binding cache.

The information indicating handling of the binding cache is information indicating any of the processes (1), (2), and (3), described hereafter. In (3) in particular, when a BC valid period (BC usable period) is also included, the value of the BC valid period is acquired and the positional information holding unit 1405 is instructed to hold the value within the binding cache to be registered. When the BC valid period is not included in the positional information registration message, the MN 10 itself can generate a suitable BC valid period or acquire a suitable value from an arbitrary server.

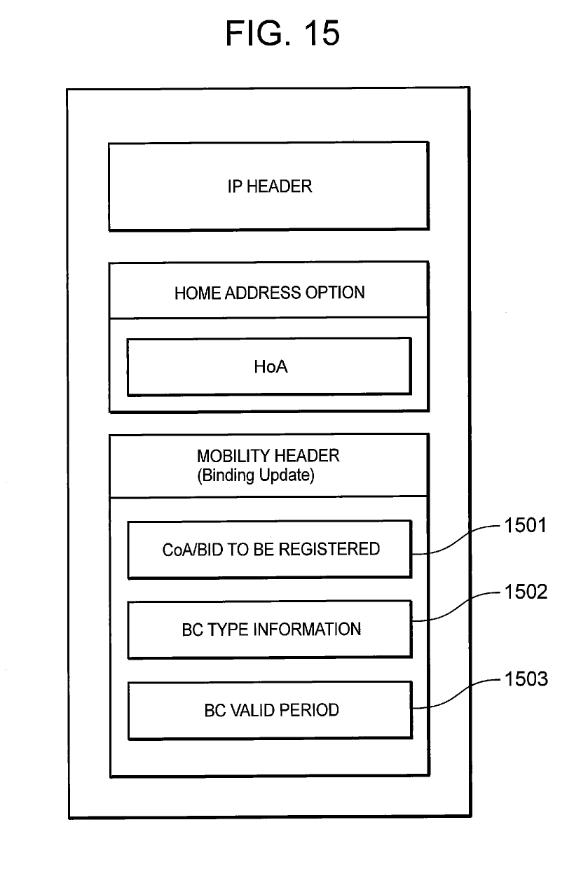

FIG. 15 is an example of a configuration of a positional information registration message when a BU message is used. As shown in FIG. 15, fields for BC type information 1502 and, furthermore, a BC valid period (BC usable period) 1503 are included in addition to a CoA/BID 1501 to be registered. The BC valid period is included when the BC type is (3). The received packet processing unit 1406 provides a function for performing processes related to a packet received by the receiving unit 1403. Data within the packet processed by the received packet processing unit 1406 is sent to the upper layer 1407 or the transmission packet generating unit 1408.

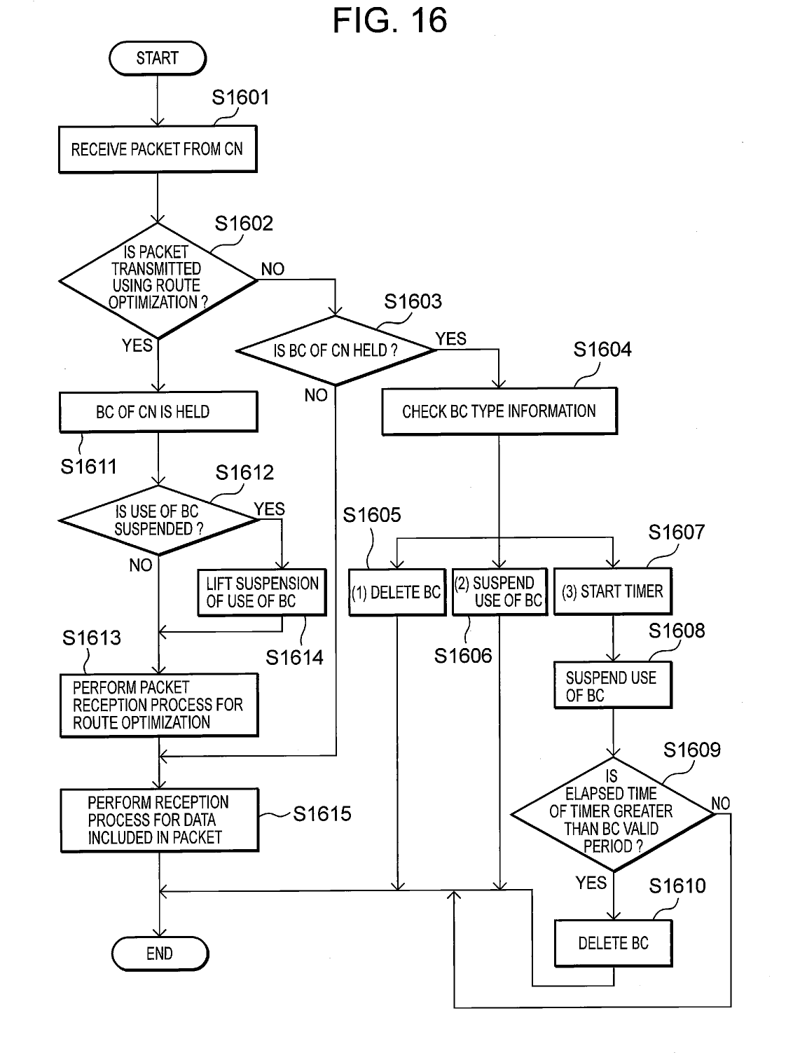

Here, an example of processes performed by the received packet processing unit 1406 will be described using FIG. 16. First, when a packet is received from the CN 20 (Step S1601), whether the packet is transmitted using route optimization is checked (Step S1602). As a method of performing the check, whether a home address option is added to the packet, whether the transmission source address is the address of the CN 20, or the like is checked. When route optimization is not used, the positional information holding unit 1405 is referenced and whether the binding cache related to the CN 20 that is the transmission source node of the packet is held is checked (Step S1603). When the binding cache is held, the BC type information is checked (Step S1604), and any of (1) to (3) below is selected and performed.

(1) “Delete the binding cache (Step S1605)” When a packet that is not route-optimized is received from the CN 20 when the binding cache of the CN 20 is held, the binding cache of the CN 20 is deleted. In this instance, the packet transmitted by the MN 10 after the binding cache is deleted is transmitted to the home address rather than the CoA of the CN 20. When the binding cache is deleted, a BC invalid notification message for giving notification that the binding cache registered by the CN 20 is invalid can be transmitted to the CN 20. At Step S1605, the post-communication-end elapsed time timer described according to the first embodiment of the present invention can be referenced. When the post-communication-end elapsed time timer is greater than the BC valid period, a judgment can be made to delete the binding cache.

(2) “Suspend use of the binding cache (Step S1606)” When a packet that does not use route optimization is received from the CN 20 when the binding cache of the CN 20 is held and, use of the binding cache of the CN 20 is suspended. In this instance, the packet transmitted by the MN 10 after use of the binding cache of the CN 20 is suspended is transmitted to the home address rather than the CoA of the CN 20. A BC confirmation message generating unit 1409 can be instructed to transmit a BC confirmation message for checking the validity of the suspended binding cache of the CN 20 to the CN 20. When a packet from the CN 20 is transmitted using route optimization while the binding cache is suspended, the suspension is lifted and use of the binding cache is resumed. At Step S1606, the post-communication-end elapsed time timer described according to the first embodiment of the present invention can be referenced. When the post-communication-end elapsed time timer is greater than the BC valid period, a judgment can be made to suspend the binding cache.

(3) “Start timer (Step S1607)” When a packet that does not use route optimization is received from the CN 20 when the binding cache of the CN 20 is held, a post-communication-start elapsed time timer is started. After the timer is started, the process in above-described (2) is performed and the use of the binding cache is suspended (Step S1608). Then, whether the elapsed time of the timer is greater than the BC valid period is judged (Step S1609). When the elapsed time is greater, the process in above-described (1) is performed and the binding cache is deleted (Step S1610).

At Step S1602, when the packet is judged to be a packet transmitted using route optimization, it is thought that the binding cache of the CN 20 is held (Step S1611), and whether use of the binding cache is suspended is checked (Step S1612). At Step S1612, when use is not suspended, after a process accompanying route optimization is performed (Step S1613), a reception process for the data included in the packet is performed (Step S1615). On the other hand, at Step S1612, when use is suspended, the suspension of use of the binding cache is lifted (Step S1614). After a process accompanying route optimization is performed (Step S1613), a reception process for the data included in the packet is performed (Step S1615). At Step S1603, when a judgment is made that the binding cache related to the CN 20 that is the transmission source node of the packet is not held, the reception process for the data included in the packet is performed (Step S1615).

Rather than suspending the use of the binding cache upon start of the timer, the binding cache can be made usable while the elapsed time of the timer is smaller than the BC valid period. In this instance, when the elapsed time of the timer becomes greater than the BC valid period, either of the above-described (2) or (3) can be selected and performed, or one of either process can always be performed.

As a method by which the MN 10 selects the above-described (1), (2), and (3), for example, the BC type information included in the positional information registration message from the CN 20 is used as described above. (1), (2), and (3) are not required to be simultaneously used as the BC type information. For example, when only (1) is used, a flag can be added in the positional information registration message and can indicate that, when the flag is set, (1) is used. When the flag is not set, the BC is managed using an ordinary method without using (1).

When only (2) is used, when only (3) is used, or the like, notification regarding use can be given to the receiving node through use of a similar flag. A method can also be used in which (3) is selected when the CN 20 requests that the post-communication-start elapsed time timer be used, and (1) or (2) is selected when the CN 20 does not request that the timer be used. In this instance, the BC type information can enable identification, with (3-1) being an instance in which (1) is performed during (3), and (3-2) being an instance in which (2) is performed during (3).

The positional information holding unit 1405 holds the binding cache registered by the communication partner (including the BC type information and the BC valid period information). When the received packet processing unit 1406 gives an instruction to delete or suspend use of the binding cache, the binding cache of the relevant CN is deleted or use is suspended. Furthermore, when an instruction is received to start the post-communication-start elapsed time timer of the communication partner, the timer within the binding cache corresponding to the communication partner is started.

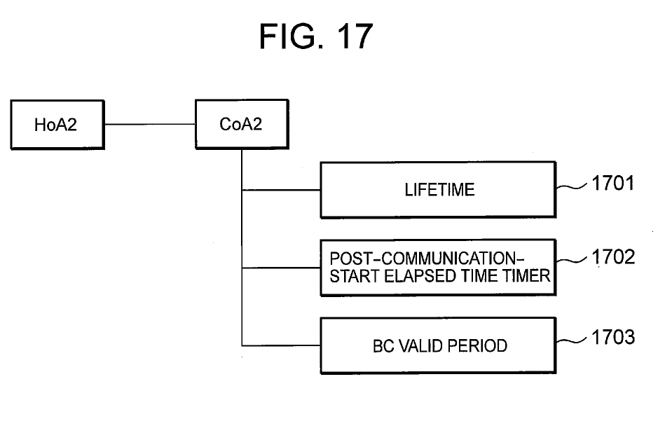

FIG. 17 shows an example of the binding cache of the CN 20 held by the position information holding unit 1405. As shown in FIG. 17, a lifetime 1701, a post-communication-start elapsed time timer 1702, and a BC valid period (BC usable period) 1703 are associated with the CoA 2 associated with the HoA 2 and managed. The lifetime 1701 indicates the lifetime of the BC.

The transmission packet generating unit 1408 receives an instruction from the upper layer 1407 or the received packet processing unit 1406, generates a packet to be transmitted to the CN 20, and judges whether the packet should be transmitted using the binding cache regarding the packet.

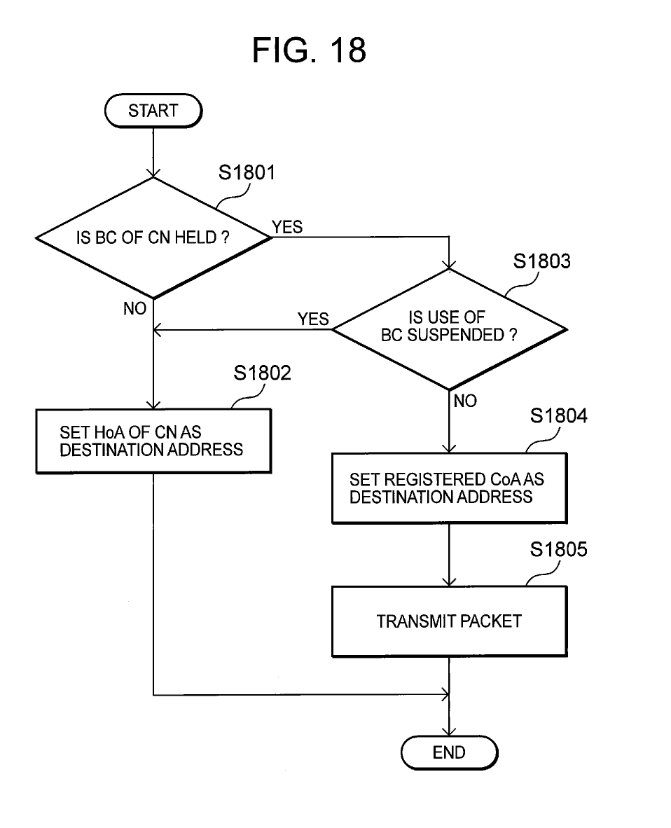

Here, an example of processes performed by the transmission packet generating unit 1408 will be described using FIG. 18. First, when a packet is transmitted to the CN 20 to start communication with the CN 20, whether a binding cache related to the CN 20 that is the transmission destination of the packet is held is checked (Step S1801). When the binding cache is not held, the packet is transmitted to the CN 20 without using route optimization. In other words, the HoA of the CN 20 is set as the destination address (Step S1802).

On the other hand, when the binding cache is held, whether use of the entry is suspended is checked (Step S1803). When use is suspended, the packet is transmitted to the CN 20 without using the binding cache. In the packet in this instance, the destination address is the home address of the CN 20 and the transmission source address is the home address of the MN 10 (route optimization not used). On the other hand, when use is not suspended, the CoA of the CN 20 held in the binding cache is set as the destination address using the held binding cache (Step S1804), and a routing header including the HoA of the CN 20 is added to the packet and the packet is transmitted (route optimization used) (Step S1805).

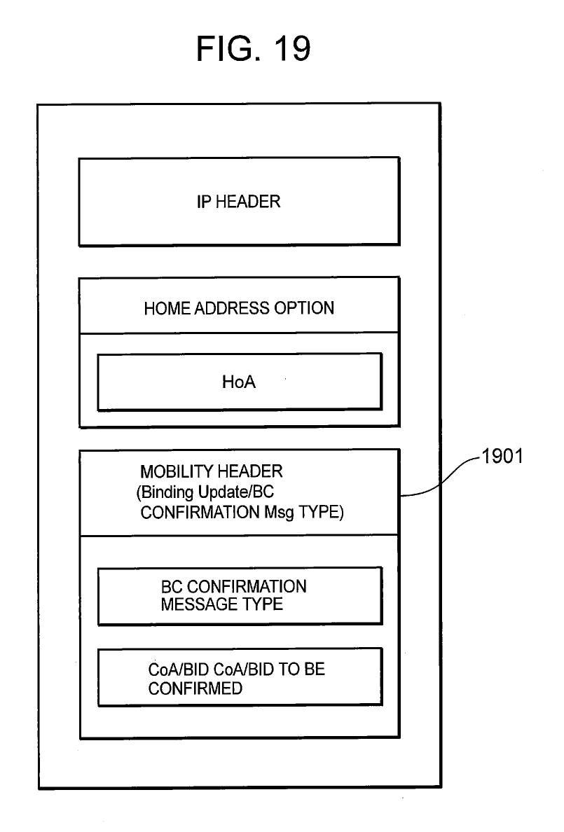

The BC confirmation message generating unit 1409 receives an instruction from the received packet processing unit 1406 and, when a packet transmitted from the CN 20 without using route optimization is received, generates a BC confirmation message for checking whether the BC registered by the CN 20 is still valid, and instructs the transmitting unit 1401 to transmit the message to the CN 20. FIG. 19 is an example of a format of the BC confirmation message using a BU message.

As shown in FIG. 19, as information indicating that the message is a BC confirmation message, a mobility header 1901 type indicating that the message is a BC confirmation message can be used, or the information can be included as a flag within an option including the CoA to be checked within the mobility header 1901. A message configured by a mobility header in mobile IPv6 is preferably used as the BC confirmation message. However, an arbitrary message can be used as long as the message can be transmitted to the CN 20. The message can also be actualized as an option added to the data packet to be transmitted to the CN 20 (destination option header and the like).

The BC confirmation response message processing unit 1410 performs processes related to a BC confirmation response message received from the CN 20. When notification that the BC is invalid is given in response to the BC confirmation message transmitted by the MN 10, the BC being held is deleted. In this instance, packets subsequently transmitted from the MN 10 to the CN 20 are transmitted via the HA of the CN 20 without using route optimization. On the other hand, when a notification that the BC is valid is given, the BC remains held and the packet is transmitted by use of route optimization on the packet to be transmitted to the CN 20.

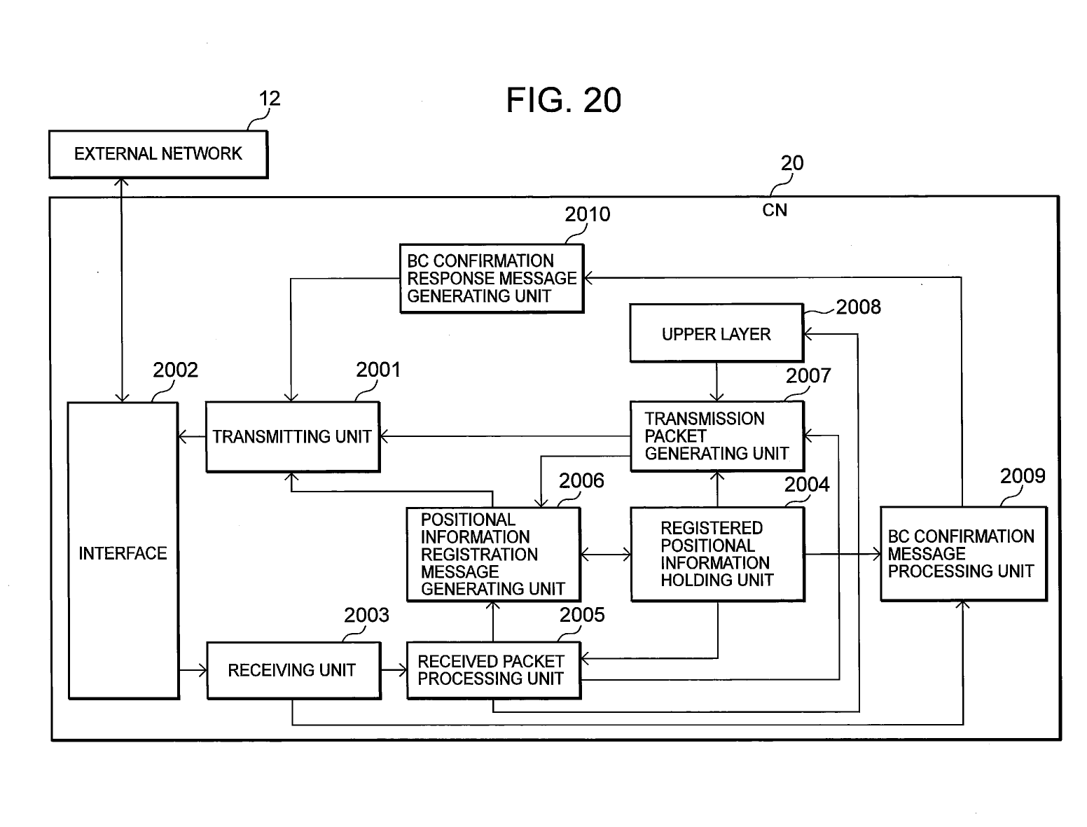

FIG. 20 is a block diagram showing an example of a configuration of the CN 20 according to the third embodiment of the present invention. The CN 20 includes, for example, the constituent elements shown in FIG. 20. A transmitting unit 2001 provides a function for transmitting a packet via an interface 2002 to a node on a network (external network 12) to which the CN 20 is connected. A receiving unit 2003 provides a function for receiving a packet via the interface 2002 from a node on a network (external network 12) to which the CN 20 is connected.

A registered positional information holding unit 2004 holds information indicating that a binding cache is registered to a communication partner (such as the MN 10). When an instruction to start time-measurement of the post-communication-start elapsed time timer of the registered positional information is received from a received packet processing unit 2005 or an upper layer 2008, the timer is started. In other words, when a packet is received from the communication partner without using route optimization, the post-communication-start elapsed time timer is started. Furthermore, when the lifetime of the binding cache registered to the MN 10 approaches expiration, a positional information registration message generating unit 2006 is instructed to generate a positional information registration message for updating the lifetime.

The positional information registration message generating unit 2006 receives an instruction from a transmission packet generating unit 2007 or the received packet processing unit 2005 and generates the positional information registration message for registering the binding cache to the communication partner. In addition, the positional information registration message generating unit 2006 receives an instruction from the registered positional information holding unit 2004 and, when the lifetime of the binding cache registered to the MN 10 approaches expiration, generates the positional information registration message for updating the lifetime.

Furthermore, BC type information indicating handling of the binding cache to be registered can also be added. When use of the above-described (3) is selected in particular, the BC valid period is included in the positional information registration message, and the transmitting unit 2001 is instructed to transmit the message.

The BC usable period is preferably set to a value suitable for the CN 20 and the MN 10 based on communication status (set to a small value when the communication status is poor and to a large value when the communication status is favorable), connection status (set to a small value when the connection status is poor and to a large value when the connection status is favorable), handover frequency (set to a small value when the handover frequency is high and to a large value when the handover frequency is low), communication data type (real-time data such as audio data and moving image data, control message, and the like), interface type (cellular, WiMAX, or WLAN), and the like. The value can be arbitrarily set based on protocol type (TCP, UDP, SIP, RTP, and the like) as well. Moreover, the value can be arbitrarily set based on the CN that is the communication party. For example, the value can be arbitrarily set depending on whether the CN belongs to the same operator.

The transmission packet generating unit 2007 generates a packet for transmitting data received from the upper layer 2008 or the received packet processing unit 2005 to the communication partner, gives the packet to the transmitting unit 2001 and instructs the transmitting unit 2001 to transmit the packet. When generating the packet, the transmission packet generating unit 2007 searches the registered positional information holding unit 2004 and judges whether the binding cache is already registered to the node at the destination address of the packet.

A BC confirmation message processing unit 2009 performs processes related to the BC confirmation message received from the MN 10, references the registered positional information holding unit 2004, and checks whether the BC of the CN 20 indicated by the information included in the BC confirmation message is valid. When a relevant BC is held in the registered positional information, a judgment is made that the BC is valid. A BC confirmation response message generating unit 2010 is instructed to generate and transmit to the MN 10 a BC confirmation response message indicating that the BC of which notification has been given is still valid.

When the relevant BC is not held in the registered positional information, a judgment is made that the BC is already invalid. The BC confirmation response message generating unit 2010 is instructed to generate and transmit to the MN 10 a BC confirmation response message indicating that the BC of which notification has been given is already invalid. Whether the BC is valid can be judged based on whether the CoA of the BC of which notification has been given is valid, namely whether the CoA is assigned to the interface. As a result, a response can be made to the confirmation request from the MN 10 even when the BC is not registered to the MN 10.

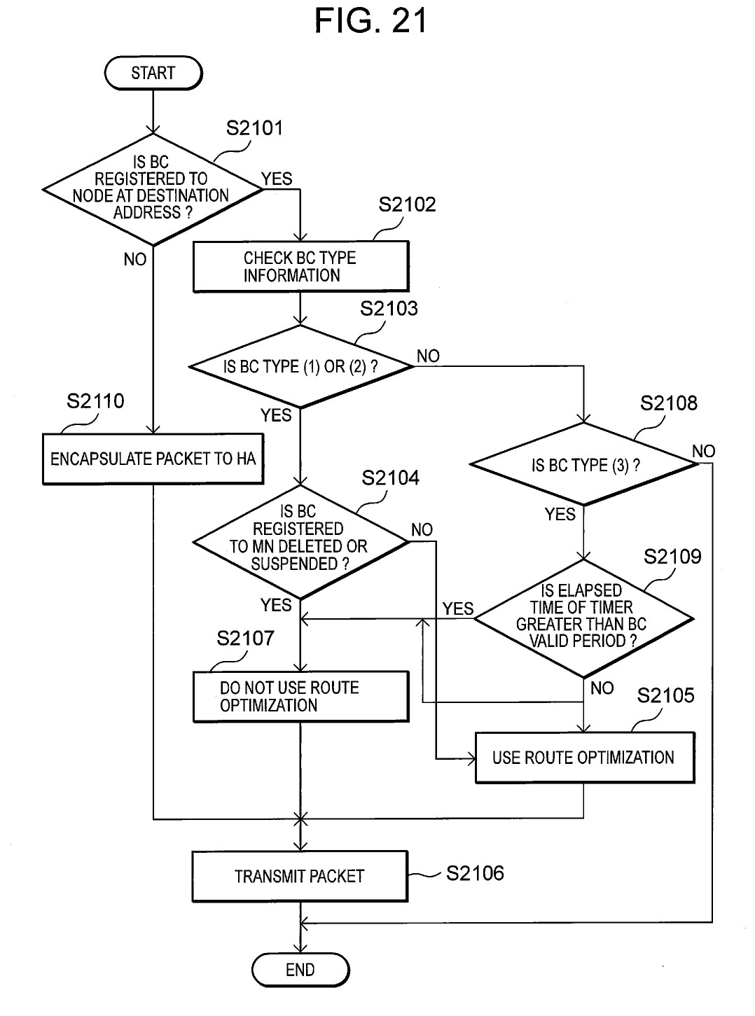

An example of processes performed by the transmission packet generating unit 2007 will be described using FIG. 21. When an instruction is given to transmit a packet, the transmission packet generating unit 200 generates a packet to be transmitted to the MN 10 and judges whether route optimization should be used for transmission of the packet. To make the judgment, first, the registered positional information holding unit 2004 is referenced and whether the BC related to the current positional information is registered to the MN 10 is checked (Step S2101). When registered positional information indicating registration to the MN 10 is held, the BC type information of the binding cache registered to the MN 10 is checked (Step S2102).

Whether the BC type is (1) or (2) is judged (Step S2103). When the BC type is (1) or (2), whether to delete or suspend the BC of the MN 10 is judged (Step S2104). When the BC type is (1), when the packet is transmitted to the MN 10 without using route optimization, the MN 10 deletes the binding cache. Therefore, when the binding cache of the MN 10 is not to be deleted, route optimization is used (Step S2105) and the packet is transmitted (Step S2106). On the other hand, when the binding cache of the MN 10 is to be deleted, the packet is transmitted (Step S2106) without using route optimization (Step S2107).

When the BC type is (2), when the packet is transmitted to the MN 10 without using route optimization, the MN 10 suspends use of the of the binding cache. Therefore, when use of the binding cache of the MN 10 is not to be suspended, route optimization is used (Step S2105) and the packet is transmitted (Step S2106). On the other hand, when use of the binding cache of the MN 10 is to be suspended, the packet is transmitted (Step S2106) without using route optimization (Step S2107).

At Step S2103, when a judgment is made that the BC type is neither (1) nor (2), whether the BC type is (3) is judged (Step S2108). When the BC type is (3), the post-communication-start elapsed time timer of the registered positional information is checked and whether the value is greater than the BC valid period (Step S2109). When the value is greater, an ordinary packet is transmitted (Step S2106) without using route optimization (Step S2107). When the value of the timer becomes greater than the BC valid period, the positional information registered to the MN 10 can be deleted. In this instance, the MN 10 that receives the packet similarly checks the post-communication-start elapsed time timer and deletes the binding cache related to the CN 20 because the value is greater than the BC valid period.

An ordinary packet is a packet in which a packet of which the transmission source address is the HoA of the CN 20 and the destination address is the HoA of the MN 10 is encapsulated by a header of which the transmission source address is the CoA of the CN 20 and the destination address is the address of the HA 2. The packet is decapsulated by the HA 2 and forwarded to the MN 10. In this instance, when the BC type information notified to the MN 10 is (3-1), because the MN 10 that receives a packet that is not route-optimized from the CN 20 deletes the binding cache, the CN 20 also deletes the registered positional information. On the other hand, when the BC type information is (3-2), because the MN 10 that receives a packet that is not route-optimized from the CN 20 suspends use of the binding cache, the CN 20 transmits a route-optimized packet when lifting the suspension of the binding cache.

On the other hand, when the timer is smaller than the BC valid period, transmission can be performed using route optimization, or transmission can be performed without using route optimization. To reset the post-communication-start time timer of the binding cache of the CN 20 being held by the MN 10 and lift the suspension of use of the binding cache, the CoA is set as the transmission source address and a home address option including the HoA is added (Step S2105), and the packet is transmitted (Step S2016). As a result, the post-communication-start elapsed time timer of the binding cache of the MN 10 is reset, and use of route optimization is started.

When the post-communication-start elapsed time timer of the binding cache of the CN 20 held by the MN 10 is not required to be reset, the packet is transmitted (Step S2106) without using route optimization (Step S2107). The packet when route optimization is used is a packet of which the transmission source address is the CoA of the CN 20, the destination address is the HoA of the MN 10, and to which the home address option including the HoA of the CN 20 is added. At Step S2101, when the registered positional information indicating registration to the MN 10 is not held, encapsulation to the HA is performed (Step S2110) and the packet is transmitted (Step S2106).

Here, when the CN 20 is connected to the external network 12 and is using the CoA 2, when the CN 20 starts communication with the MN 10 to which a BC having a BC type of (3) is registered will be considered. When the post-communication-start elapsed time timer of the registered positional information held by the CN 20 is greater than the BC valid period, the CN 20 transmits an ordinary packet to the MN 10 without using route optimization. In this instance, regardless of holding the BC related to the CN 20, because a packet that does not use route optimization is received, the MN 10 starts the post-communication-start elapsed time timer.

When the BC type is (1), when occurrence of a handover of the CN 20 is approaching or when a handover process is in progress, even when the packet can be transmitted using the CoA registered to the MN 10, a selection can be made to transmit the packet without using route optimization. As a result, because the MN 10 deletes the binding cache upon receiving the packet from the CN 20, a message for deleting the binding cache or a message for updating the binding cache is not required to be transmitted to the MN 10 after the handover.

When the binding cache is not registered to the MN 10, namely when the CN 20 moves and uses a CoA differing from the CoA registered to the MN 10, until the new CoA is registered to the MN 10, a packet using the new CoA cannot be transmitted to the MN 10. Therefore, packet transmission is performed via the HA. Packet transmission via the HA is similarly performed when the CN 20 moves to the home network and does not have a CoA.

In this way, as a result of the MN 10 and the CN 20 according to the third embodiment of the present invention, regardless of the MN 10 holding the binding cache of the CN 20, when the packet received by the MN 10 from the CN 20 is transmitted without route optimization, packet loss caused by the MN 10 using an invalid binding cache can be prevented by the binding cache of the CN 20 being deleted, suspended, or the post-communication-start elapsed time timer being started.

As a result of the binding cache being suspended and, furthermore, the binding cache being deleted when the value of the timer becomes greater than the BC valid period, needless deletion of the binding cache can be prevented even when the CN 20 chooses to temporarily stop using route optimization.

As a result of the CN 20 giving notification of the BC type information in the positional information registration message, the MN 10 can be instructed to perform a process preferable for the CN 20 and the MN 10 can be made to perform a process suitable for the state of the CN 20. For example, even when a binding cache of which the BC type is registered as (1) to the MN 10 remains after the end of communication with the MN 10, when the CN 20 transmits a packet without using route optimization when restarting communication with the MN 10, the old binding cache is deleted by the MN 10. Therefore, misuse by the MN 10 can be prevented, and processing load accompanying use of route optimization can be reduced.

As a result of (1) being used, even when the CN 20 communicating with the MN 10 performs a handover from an external network to a home network, a message requesting that the binding cache registered to the MN 10 be deleted is not required to be transmitted to the MN 10, and the binding cache can be deleted simply by an ordinary packet transmission being performed. Therefore, processing load accompanying message transmission can be reduced.

Similar effects can be achieved even when some functions of the MN 10 according to the third embodiment of the present invention are applied to the HA 14 managing the positional information of the MN 10. The MN 10 transmits a BU message including the BC type, such as that shown in FIG. 15, to the HA 14. The HA 14 sets the BC type within the BU message received from the MN 10 in the binding cache of the MN 10. Then, when a packet using a CoA differing from the previous CoA is received from the MN 10, the HA 14 determines handling of the binding cache based on the BC type. For example, when the BC type is (1), the HA 14 deletes the binding cache. When the BC type is (2), the HA 14 suspends use of the binding cache. When the BC type is (3-1) or (3-2), the timer is started before the binding cache is deleted or suspended. When the value of the timer exceeds the BC valid period, deletion or suspension is performed. In this instance, the value of the timer is reset when the MN 10 again restarts communication with the CN using the CoA registered in the binding cache. Therefore, when the MN 10 does not communicate for a brief period of time and the timer exceeds the BC valid period, use of the binding cache is suspended without the binding cache being used as a forwarding destination.

When the HA 14 has a binding cache other than the binding cache that is deleted or of which use is suspended (when the MN 10 holds a plurality of interfaces), the HA 14 selects and uses the other binding cache as the next forwarding destination. On the other hand, even when another binding cache is present, if the timer of the binding cache also exceeds the BC valid period, the binding cache with the timer having the shorter elapsed time or a shorter amount of time exceeded from the BC usable period is selected. When another binding cache is not present, the HA 14 cancels deletion or suspension of use of the binding cache and forwards the received packet to the registered CoA. As a result, a binding cache that is more likely to be valid can be selected. Instead of packet loss occurring in the HA 14, effects such as re-forwarding or buffering by a gateway within the network to which the MN 10 is connected and the like can be expected. When a binding cache indicating connection to the home network is present (HoA is set as the CoA) as another binding cache, the HA 14 forwards the packet to the HoA without encapsulating the packet. Even when another binding cache of the MN 10 is not present, when it is known that the MN 10 is connected to the home network, forwarding to the HoA can be performed.

### Fourth Embodiment

According to a fourth embodiment of the present invention, the BC that is the positional information registered to the MN 10 by the CN 20 is associated with a communication (session or flow) performed between the CN 20 and the MN 10, and the MN 10 selects and performs any of (1), (2), and (3) described according to the third embodiment of the present invention, after communication with the CN 20 has ended. In a manner similar to that according to the third embodiment, (1), (2), and (3) are not required to be simultaneously used as the BC type information. For example, when only (1) is used, a flag can be added in the positional information registration message and can indicate that, when the flag is set, (1) is used. When the flag is not set, the BC is managed using an ordinary method without using (1). When only (2) is used, when only (3) is used, or the like, notification regarding use can be given to the receiving node through use of a similar flag.

A method can also be used in which (3) is selected when the CN 20 requests that the post-communication-start elapsed time timer be used. When use of the timer is not requested, (1) or (2) is selected. In this instance, the BC type information can enable identification, with (3-1) being an instance in which (1) is performed during (3), and (3-2) being an instance in which (2) is performed during (3).

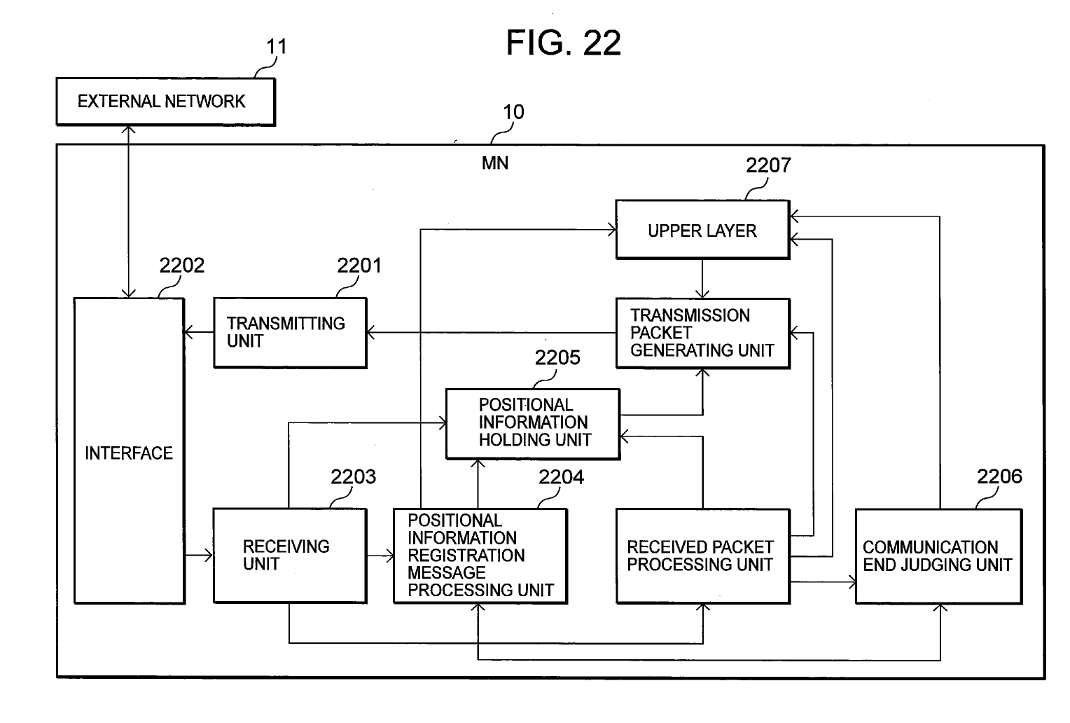

A network configuration according to the fourth embodiment of the present invention is the same as that shown in FIG. 1. Description thereof is omitted. FIG. 22 is a block diagram of an example of a configuration of the MN 10 according to the fourth embodiment of the present invention. The MN 10 includes, for example, the constituent elements shown in FIG. 2. A transmitting unit 2201 provides a function for transmitting a packet via an interface 2202 to a node on a network (external network 11) to which the MN 10 is connected. A receiving unit 2203 provides a function for receiving a packet via the interface 2202 from a node on a network (external network 11) to which the MN 10 is connected.

A positional information registration message processing unit 2204 acquires positional information included in the positional information registration message received from the CN 20 and holds the information in a positional information holding unit 2205. When the BC type information is also included, the BC type information is also acquired and held. In this instance, when the above-described (3) is specified in particular and a value of the BC valid period (BC usable period) is also included, the value is also acquired and held.

As an example differing from the method according to the third embodiment of the present invention in which processes are performed using as a trigger the reception of a packet that does not use route optimization from the CN 20, processes are performed using as a trigger the registered positional information being associated with communication (session) with the CN 20 and the communication ending. When communication association information (such as a flag) is included within the positional information registration message as information requesting this process, the information is acquired and held by the positional information holding unit 2205. Notification of the communication association information can be given as a piece of BC type information according to the third embodiment of the present invention.

The positional information registration message processing unit 2204 notifies a communication end judging unit 2206 of information related to the CN 20 to detect the end of communication and, when the communication (session) with the CN 20 ends, requests notification of the end of communication (session) with the CN 20 to the positional information registration message processing unit 2204.

Information for identifying the communication associated with the registered binding cache can be included in the positional information registration message. In this instance, the communication end judging unit 2206 is notified of the information for identifying the communication in addition to the information related to the CN 20. As information identifying the communication, arbitrary information can be used as long as the information can express a portion of or the overall communication (session or flow) performed between the CN 20 and the MN 10, such as a session ID indicating a specific session, a flow ID indicating a specific flow, an address (destination address or transmission source address) or a port number, a protocol ID, and the like. When flow information is already registered, only the flow ID indicating the w information need be included.

The communication end judging unit 2206 monitors the status of communication with a communication partner and, when the end of communication with the CN 20 is detected, notifies the positional information registration message processing unit 2204 that the communication has ended. The positional information registration message processing unit that has received the notification of the end of communication references the positional information holding unit 2205, and deletes the binding cache when the communication association information is held in the binding cache of the CN 20. When the BC type described according to the third embodiment of the present invention is indicated separately from the communication association information, processes can be performed in adherence to the BC type information of the binding cache of the CN 20. When the BC type information is (1), the binding cache of the CN 20 is deleted when notification is given that the communication with the CN 20 has ended. This instance is similar to when the type of the binding cache is the type of the communication association information, as described above.

On the other hand, when the BC type information is (2), use of the binding cache of the CN 20 is suspended. Furthermore, when the BC type information is (3), the post-communication-end elapsed time timer is started when the communication with the CN 20 ends. In this instance, the process performed by comparison of the value of the post-communication-end elapsed time timer and the BC valid period when the MN 10 restarts communication with the CN 20 and when the MN 10 receives communication restarted by the CN 20 is similar to the process performed by comparison of the value of the post-communication-end elapsed time timer and the BC valid period described according to the first and second embodiments of the present invention. Therefore, description thereof is omitted. When the BC type information is (3), the post-communication-start elapsed time timer and the BC valid period can be compared when the communication with the CN 20 ends. When the value of the timer is greater than the BC valid period, the binding cache is deleted. On the other hand, when the value is smaller, a judgment can be made not to delete the binding cache.

As a method by which the communication end judging unit 2206 detects that communication with the CN 20 has ended, there is a method in which an inquiry is made to the upper layer 2207 and whether the communication has ended is checked, a method in which a request is made to the upper layer 2207 for notification, and the like. The end of the communication can be confirmed when the packets being transmitted and received with between the MN 10 and the CN 20 are monitored, and a packet indicating the end of communication based on a protocol used by the upper layer 2207 (such as a FIN message and an ACK message of the TCP, or a BYE message and an ACK message of the SIP) is detected. In addition, a judgment can be made that communication with the CN 20 has ended when communication is not performed for a certain amount of time (expiration of the lifetime).

The positional information registration message processing unit 2204 can confirm with the communication end judging unit 2206 or the upper layer 2207 regarding whether the communication with the CN 20 of the BC being held has ended. As a result of the confirmation, when it is found that the communication has ended, a process is performed in adherence to the BC type information of the binding cache of the communication partner. The timing at which confirmation is made regarding whether communication has ended can be judged based on the remaining time of the lifetime of the binding cache, the time elapsed from the start of communication with the CN 20, when occurrence of a handover is approaching, and the like.

When a certain communication is specified, in the communication with the CN 20, the above-described process can be performed when the specified communication ends. The process by the communication end judging unit 2206 can be actualized by the upper layer 2207. The upper layer 2207 can notify the positional information registration message processing unit 2204 that the communication with the CN 20 has ended.

When an inquiry regarding whether communication with the CN 20 has ended is received from the positional information registration message processing unit 2204 or the communication end judging unit 2206, the upper layer 2207 returns a result regarding whether the communication has ended. In addition, when information related to the communication with the CN 20 is received and the communication ends, notification is given that the communication has ended. The positional information holding unit 2205 receives an instruction from the positional information registration message processing unit 2204 to register, suspend, or delete the binding cache of the CN 20, and performs the process.

In this way, as a result of the MN 10 and the CN 20 according to the fourth embodiment of the present invention, as a result of the MN 10 deleting or suspending the binding cache of the CN 20, or starting the post-communication-start elapsed time timer upon end of communication with the CN 20, packet loss caused by the MN 10 using an invalid binding cache can be prevented. Furthermore, as a result of the binding cache being suspended and the binding cache being further deleted when the value of the timer becomes greater than the BC valid period, unnecessary deletion of the binding cache can be prevented even when the CN 20 chooses to temporarily stop using route optimization.

As a result of the CN 20 giving notification of the BC type information within the positional information registration message, the MN 10 can be instructed to perform processes preferable for the CN 20. The MN 10 can be made to perform processes suitable for the state of the CN 20. For example, as a result of the BC type information (1) being registered to the MN 10, the MN 10 deletes the binding cache of the CN 20 after communication with the MN 10 ends. Therefore, misuse by the MN 10 can be prevented. As a result of (1) being used, a message requesting that the binding cache registered to the MN 10 be deleted is not required to be transmitted to the MN 10 after communication with the MN 10 ends. Processing load accompanying message transmission can be reduced.

Similar effects can be achieved even when some functions of the MN 10 according to the fourth embodiment of the present invention are applied to the HA 14 managing the positional information of the MN 10. The MN 10 transmits a BU message including the communication association information and the flow information to the HA 14. The HA 14 sets the communication association information within the BU message received from the MN 10, as well the flow information and the like, in the binding cache of the MN 10. Then, when the HA 14 detects that a packet destined for the CN 20 received from the MN 10 or a packet destined for the MN 10 received from the CN 20 matches communication (session or flow) associated in the binding cache and that the communication has ended, the binding cache is deleted. When the BC type is specified, handling of the binding cache is judged based on the BC type. For example, when the BC type is (1), the HA 14 deletes the binding cache as described above. When the BC type is (2), the HA 14 suspends use of the binding cache. When the BC type is (3-1) or (3-2), before the binding cache is deleted or suspended, the timer is started. When the value of the timer exceeds the BC valid period, deletion or suspension is performed. In this instance, the value of the timer is reset when the MN 10 again restarts communication with the CN 20 using the CoA registered in the binding cache. Therefore, when the MN 10 does not communicate for a brief period of time and the timer exceeds the BC valid period, use of the binding cache is suspended without the binding cache being used as a forwarding destination.

When the HA 14 has a binding cache other than the binding cache that is deleted or of which use is suspended (when the MN 10 holds a plurality of interfaces), the HA 14 selects and uses the other binding cache as the next forwarding destination. On the other hand, even when another binding cache is present, if the timer of the binding cache also exceeds the BC valid period, the binding cache with the timer having the shorter elapsed time or a shorter amount of time exceeded from the BC usable period is selected. When another binding cache is not present, the HA 14 cancels deletion or suspension of use of the binding cache and forwards the received packet to the registered CoA. As a result, a binding cache that is more likely to be valid can be selected. Instead of packet loss occurring in the HA 14, effects such as re-forwarding or buffering by a gateway within the network to which the MN 10 is connected and the like can be expected. When a binding cache indicating connection to the home network is present (HoA is set as the CoA) as another binding cache, the HA 14 forwards the packet to the HoA without encapsulating the packet. Even when another binding cache of the MN 10 is not present, when it is known that the MN 10 is connected to the home network, forwarding to the HoA can be performed.

Each functional block used in the descriptions of the embodiments of the present invention, described above, can be actualized as a large scale integration (LSI) that is typically an integrated circuit. Each functional block can be individually formed into a single chip. Alternatively, some or all of the functional blocks can be included and formed into a single chip. Although referred to here as the LSI, depending on differences in integration, the integrated circuit can be referred to as the integrated circuit (IC), a system LSI, a super LSI, or an ultra LSI.

The method of forming the integrated circuit is not limited to LSI and can be actualized by a dedicated circuit or a general-purpose processor. A field programmable gate array (FPGA) that can be programmed or a reconfigurable processor of which connections and settings of the circuit cells within the LSI can be reconfigured can be used after LSI manufacturing.

Furthermore, if a technology for forming the integrated circuit that can replace LSI is introduced as a result of the advancement of semiconductor technology or a different derivative technology, the integration of the functional blocks can naturally be performed using the technology. For example, the application of biotechnology is a possibility.

### INDUSTRIAL APPLICABILITY

The mobile terminal of the present invention can prevent occurrence of packet loss and prevent communication delay. In addition, the mobile terminal can reduce processing load and traffic accompanying unnecessary transmission of BC messages. Therefore, the mobile terminal is useful as a mobile terminal that performs packet communication via a communication network with a communication partner, and the like.

1. A mobile terminal that performs packet communication via a communication network with a communication terminal that is a communication partner of the mobile terminal using a binding cache including address information of the communication terminal, the mobile terminal comprising:
a measuring unit configured to measure an amount of time elapsed from the end of the latest communication with the communication terminal to the start of new communication;
a storage unit configured to store information on a valid period of the binding cache;
a judging unit configured to judge whether the measured elapsed time exceeds the valid period of the binding cache when communication with the communication terminal is started;
a packet generating unit configured, when the elapsed time is judged to exceed the valid period of the binding cache, to set a home address of the communication terminal as a destination address of a packet to be transmitted and to generate the packet; and
a transmitting unit configured to transmit the generated packet to the communication terminal.

2. The mobile terminal according to claim 1, wherein the packet generating unit adds the address information of the communication terminal in the binding cache to the packet.

3. The mobile terminal according to claim 1, further comprising:
a receiving unit configured to receive a message including information on the valid period of the binding cache from the communication terminal, wherein
the storage unit acquires the information on the valid period of the binding cache included in the received message and stores the acquired information.

4. The mobile terminal according to claim 1, wherein the measuring unit starts measuring the elapsed time when communication with the communication terminal ends.

5. A mobile terminal that performs packet communication via a communication network with a communication terminal that is a communication partner of the mobile terminal using a binding cache including address information of the communication terminal, the mobile terminal comprising:
a measuring unit configured to measure an amount of time elapsed from the end of the latest communication with the communication terminal to the start of new communication;
a storage unit configured to store information on a valid period of the binding cache;
a judging unit configured, when the binding cache includes a plurality of pieces of address information of the communication terminal, to judge whether the elapsed time measured when communication with the communication terminal is started and that corresponds to each piece of address information exceeds the valid period of the binding cache;
a packet generating unit configured, when all elapsed times corresponding to the pieces of address information are judged to exceed the valid period of the binding cache, to generate a packet including notification that the pieces of address information of the communication terminal within the binding cache are pieces of address information that have already exceeded the valid period of the binding cache; and
a transmitting unit configured to transmit the generated packet to the communication terminal.

6. A mobile terminal that performs packet communication via a communication network with a communication terminal that is a communication partner of the mobile terminal using a binding cache including address information of the communication terminal, the mobile terminal comprising:
a receiving unit configured to receive a packet from the communication terminal;
a judging unit configured to judge whether the received packet is a packet that is encapsulated by the home agent of the mobile terminal;
a packet generating unit configured, when the packet is judged to be encapsulated by the home agent, to generate a packet in which address information of the mobile terminal itself is set as a transmission source address and to which a home address option including the home address of the mobile terminal itself is added; and
a transmitting unit configured to transmit the generated packet to the communication terminal.

7. The mobile terminal according to claim 6, wherein the address information of the mobile terminal is added to the encapsulated packet.

8. The mobile terminal according to claim 6, further comprising:
a first message generating unit configured to generate a message including an instruction to the communication terminal to start measuring the amount of time elapsed from the end of communication to the start of new communication when communication with the mobile terminal ends, wherein
the transmitting unit transmits the generated message to the communication terminal.

9. The mobile terminal according to claim 6 further comprising:
a second message generating unit configured to generate a message including information on a valid period of a binding cache of the mobile terminal held by the communication terminal, wherein
the transmitting unit transmits the generated message to the communication terminal.

10. The mobile terminal according to claim 6, further comprising:
a processing unit configured, when the packet received by the receiving unit is judged to be a packet encapsulated by the home agent of the mobile terminal, to reset the elapsed time stored in the mobile terminal itself and measured from the end of communication with the communication terminal to the start of new communication.

11. The mobile terminal according to claim 10, wherein:
when the mobile terminal itself has a plurality of interfaces and a packet received by the receiving unit is judged to be a packet encapsulated by the home agent of the mobile terminal, the processing unit resets the elapsed time corresponding to the address information of each interface.

12. A mobile terminal that performs packet communication via a communication network with a communication terminal that is a communication partner of the mobile terminal using a binding cache including address information of the communication terminal, the mobile terminal comprising:
a receiving unit configured to receive a packet transmitted from the communication terminal;
a judging unit configured to judge whether the received packet is a packet transmitted via a home agent of the mobile terminal;
a selecting unit configured, when the packet is judged to be a packet transmitted via the home agent, to select processing information that is information stored with the binding cache in a predetermined storage area and related to a predetermined process performed on the binding cache; and
a processing unit configured to perform a process on the binding cache based on the selected processing information.

13. A mobile terminal that performs packet communication via a communication network with a communication terminal that is a communication partner of the mobile terminal using a binding cache including address information of the communication terminal, the mobile terminal comprising:
a judging unit configured to judge whether communication with the communication terminal has ended;
a selecting unit configured, when the communication with the communication terminal is judged to have ended, to select processing information that is information stored with the binding cache in a predetermined storage area and related to a predetermined process performed on the binding cache; and
a processing unit configured to perform a process on the binding cache based on the selected processing information.

14. The mobile terminal according to claim 12, wherein the predetermined process is at least one process among deletion of the binding cache, suspension of use of the binding cache, and start of measurement of an amount of time elapsed from reception of the packet to the start of new communication.

15. The mobile terminal according to claim 12, wherein the processing information is information included in a message transmitted from the communication terminal in advance.

16. A mobile terminal that performs packet communication via a communication network with a communication terminal that is a communication partner of the mobile terminal using a binding cache including address information of the communication terminal, the mobile terminal comprising:
a message generating unit configured, when generating a message for registering the binding cache to the communication terminal, to generate a message including processing information related to a predetermined process performed on the biding cache when the packet received from the mobile terminal is a packet that passes through the home agent of the communication terminal; and
a transmitting unit configured to transmit the generated message to the communication terminal.

17. A mobile terminal that performs packet communication via a communication network with a communication terminal that is a communication partner of the mobile terminal using a binding cache including address information of the communication terminal, the mobile terminal comprising:
a message generating unit configured, when generating a message for registering the binding cache to the communication terminal, to generate the message including processing information related to a predetermined process performed on the binding cache when communication with the mobile terminal is judged to have ended; and
a transmitting unit configured to transmit the generated message to the communication terminal.

18. The mobile terminal according to claim 16, wherein the predetermined process is at least one process among deletion of the binding cache, suspension of use of the binding cache, and start of measurement of an amount of time elapsed from reception of the packet to the start of new communication.

19. The mobile terminal according to claim 13, wherein the predetermined process is at least one process among deletion of the binding cache, suspension of use of the binding cache, and start of measurement of an amount of time elapsed from reception of the packet to the start of new communication.

20. The mobile terminal according to claim 17, wherein the predetermined process is at least one process among deletion of the binding cache, suspension of use of the binding cache, and start of measurement of an amount of time elapsed from reception of the packet to the start of new communication.
